(19) United States
(12) Patent Application Publication
(10) Pub. No.: US 2005/0143857 A1
(43) Pub. Date: Jun. 30, 2005

(54) Article identification

(76) Inventor: Munroe Chirnomas, Morris Township, NJ (US)

Correspondence Address: LAWRENCE C. EDELMAN, IP COUNSEL FASTCORP, 60 E. HANOVER AVE, B-2, MORRIS PLAINS, NJ, 07950, US

(21) Appl. No.: 11/065,536

(22) Filed: Feb. 24, 2005

Related U.S. Application Data
(63) Continuation of application No. 09/998,989, filed on Nov. 29, 2001.
Application No. 09/998,989 is a continuation-in-part of application No. PCT/US01/16853, filed on May 23, 2001.
Application No. 09/998,989 is a continuation-in-part of application No. PCT/US01/16893, filed on May 23, 2001.
Application No. 09/998,989 is a continuation-in-part of application No. PCT/US01/16837, filed on May 23, 2001.
Application No. 09/998,989 is a continuation-in-part of application No. PCT/US01/16847, filed on May 23, 2001.
Application No. 09/998,989 is a continuation-in-part of application No. PCT/US01/16846, filed on May 23, 2001.
Application No. 09/998,989 is a continuation-in-part of application No. PCT/US01/16894, filed on May 23, 2001.
(63) Continuation-in-part of application No. 09/633,477, filed on Aug. 7, 2000, now Pat. No. 6,547,096.
(60) Provisional application No. 60/257,316, filed on Dec. 21, 2000.
(60) Provisional application No. 60/206,363, filed on May 23, 2000.
(60) Provisional application No. 60/206,363, filed on May 23, 2000.
(60) Provisional application No. 60/206,363, filed on May 23, 2000.
(60) Provisional application No. 60/206,363, filed on May 23, 2000.
(60) Provisional application No. 60/206,363, filed on May 23, 2000.
(60) Provisional application No. 60/206,363, filed on May 23, 2000.
(60) Provisional application No. 60/206,363, filed on May 23, 2000.

(51) Int. Cl. G06F 17/00

(52) U.S. Cl. 700/244

(57) ABSTRACT

The present invention relates to improvements in the design and operation of an article dispensing apparatus used in conjunction with an article identification device, and is particularly useful in the environment of a vending machine. In one embodiment, the article dispensing apparatus comprises a storage volume for storing articles to be dispensed; an article extracting device including a free end for selectively grasping to and extracting an article from the storage volume; and a user interface and control apparatus for allowing a user of the dispensing apparatus to initiate an article dispensing operation, and to cause controlled movement of the article extracting device so that a selected article is extracted from the article storage area and moves along a common path to a point within the dispensing apparatus that is associated with a dispensing area of the dispensing apparatus. An article identification device, mounted at a point within the dispensing apparatus that is near the common path, is operated so as to provide identification scanning of an article while the article is still being grasped by the article extracting device and while the article is still being moved by the article extracting device, as the article moves along the common path during the dispensing operation.

### CROSS-REFERENCE TO RELATED APPLICATIONS

This application claims priority of and is a continuation of U.S. patent application Ser. No. 09/998,989, filed Nov. 29, 2001, entitled ARTICLE IDENTIFICATION, which application claims priority of and is a continuation in part of: (i) PCT/US01/16853, filed May 23, 2001, entitled METHOD AND APPARATUS FOR INCLUDING ARTICLE IDENTIFICATION IN AN ARTICLE HANDLING DEVICE; (ii) PCT/US01/16893, filed May 23, 2001, entitled METHODS OF DOING THE BUSINESS OF MACHINE VENDING (which claims the benefit of U.S. Provisional Patent Application No. 60/257,316, filed Dec. 21, 2000, entitled METHOD AND APPARATUS FOR ARTICLE HANDLING, SUCH AS FOR A VENDING MACHINE); (iii) PCT/US01/16837, filed May 23, 2001, entitled METHOD AND APPARATUS FOR CONTROLLING A VENDING MACHINE; (iv) PCT/US01/16847, filed May 23, 2001, entitled METHOD AND APPARATUS FOR STORING ARTICLES FOR USE WITH AN ARTICLE HANDLING DEVICE; (v) PCT/US01/16846, filed May 23, 2001, entitled METHOD AND APPARATUS FOR HOSE STORAGE IN AN ARTICLE HANDLING DEVICE; (vi) PCT/US01/16894, filed May 23, 2001, entitled METHOD AND APPARATUS FOR POSITIONING AN ARTICLE HANDLING DEVICE, all of the above patent applications claim the benefit of U.S. Provisional Patent Application No. 60/206,363, filed May 23, 2000, entitled METHOD AND APPARATUS FOR ARTICLE HANDLING, SUCH AS FOR A VENDING MACHINE.

This application also claims priority of and is a continuation in part of: (vii) International Publication No. WO 01/11578, filed Aug. 7, 2000, entitled VENDING MACHINE (which claims the benefit of U.S. Provisional Patent Application No. 60/147,832, filed Aug. 7, 1999, entitled VENDING MACHINE), and (viii) its corresponding U.S. application U.S. Ser. No. 09/633,477. (ix) U.S. Provisional Patent Application No. 60/257,316, filed Dec. 21, 2000 and entitled METHOD AND APPARATUS FOR ARTICLE HANDLING, SUCH AS FOR A VENDING MACHINE; and (x) U.S. Provisional Patent Application No. 60/261,964, filed Jan. 16, 2001 and entitled METHOD AND APPARATUS FOR ARTICLE HANDLING AND DISPENSING DEVICES; (xi) U.S. Provisional Patent Application No. 60/294,284, filed May 29, 2001, entitled METHOD AND APPARATUS FOR QUICK CHANGE DISPLAY GRAPHICS ON A MERCHANDISER; and (xii) U.S. Provisional Patent Application No. 60/296,675, filed Jun. 7, 2001, entitled METHOD AND APPARATUS FOR ARTICLE HANDLING, SUCH AS WITH A VENDING MACHINE.

This application also claims priority of and is a continuation in part of: (xiii) U.S. Provisional Patent Application No (attorney docket # 01PR19US) filed Nov. 23, 2001 in the name of Munroe Chirnomas and entitled MACHINE FOR VENDING ARTICLES AND METHODS ASSOCIATED THEREWITH, and of (xiv) U.S. Provisional Patent Application No (attorney docket # 01PA20US) filed Nov. 23, 2001 in the name of Munroe Chirnomas and entitled METHOD AND APPARATUS FOR VENDING GOODS. The entire disclosures of all of the above patent applications are incorporated herein by reference, at least for US purposes.

### BACKGROUND OF THE INVENTION

1. Field of the Invention

The present invention relates generally to improvements in the design and operation of an article handling apparatus used in conjunction with an article identification device, and is particularly useful in the environment of an article handling device as used a vending machine.

2. Description of the Prior Art

Most prior art article handling mechanisms, more specifically referred to in the description of the present invention as being in the environment of a point-of-sale (POS) article dispenser, rely on a multitude of motors, switches and solenoids for moving various portions of the handling mechanism, and handling of the articles themselves, such as packaged products. Most such machines require one motor, switch and/or solenoid dedicated for each row, column or type of article or package to be handled or dispensed therefrom. Such machines generally suffer from numerous disadvantages, such as poor reliability due to mechanical failures, as well known by those skilled in this art.

U.S. Pat. No. 5,240,139 represents a significant improvement in article handling devices. It describes the use of a negative air pressure lifter (i.e., article pickup or handling mechanism), which uses suction, i.e., a reduced or so-called “negative” air pressure created by a partial vacuum, for making a secure contact to an article to be retrieved by entering the open top of an article storage bin located in a refrigerated storage area of a vending machine. Although robotic, and specifically suction-type lifting mechanisms are in common use in factory settings, where space limitations are generally relaxed, their use in tight confines, such as an article vending machine, has not gained wide acceptance. Due to the greater reliability and versatility of vending machines of the type which utilizes suction technology for grasping and moving selected articles, it would be desirable to develop new techniques and methods for the operation and control of such machines, as well as for other more generalized article handling mechanisms. It is noted that article identification in conjunction with an article handling is not provided for in this US patent.

U.S. Pat. No. 5,272,321 entitled AUTOMATIC VENDING MACHINE HAVING A BAR CODE READER AND BAR-CODED COLUMNS AND SWITCHES assigned to Sanyo Electric Co., describes a vending apparatus for handling articles for which preprinted barcodes have been applied. During a service mode operation of the machine (e.g. during refilling) a handheld bar code reader is used to scan a preprinted sheet of bar codes which is located on the inside of the front door of the vending machine. The sheet includes barcodes for programming the CPU of the machine with the identification of the articles stored in the machine, identification of the storage columns in which those articles have been loaded, and identification of which user selection switches have been designated for activating dispensing of a given article from a given column. Although the technique disclosed in this patent facilitates rapid and accurate programming of the vending machine during servicing, it can not prevent dispensing of an incorrect product due to erroneous loading of the product into the machine, e.g., such as due to either inadvertently or purposefully loading an incorrect product into an incorrect storage column.

JP 4123192A2 entitled DEVICE FOR PREVENTING ERRONEOUS THROW-IN OF COMMODITY OF VENDING MACHINE assigned to Sanyo Electric Co., discloses the use of a bar code reader at the top, input end, of each article storage column in a vending machine. During refilling of the machine with articles, if the bar code reader at the top of each article storage column reads a product code that is not preprogrammed to be stored in that column, the vending machine controller operates a gate which will prevent that article from further entrance into the article storage column. In this way, erroneous refilling of the article storage columns is prevented. However, it would be possible to relatively easily “trick” or cheat a vending machine of this type by, for example, disabling the bar code scanner at the input end of each storage column, or by holding a false bar code in front of the reader during refilling of that column with a different, maybe erroneous and possibly inferior, product.

JP4123194A2 entitled ERRONEOUS SALE PREVENTING DEVICE FOR VENDING MACHINE, also assigned to Sanyo Electric Co., includes a handheld bar code scanner and programming sheet of bar codes for programming the controller of the vending machine during a set up mode (a technique similar that noted above in U.S. Pat. No. 5,272,321), as well as a fixed-position bar code scanner located just above the product exit chute of the vending machine, for reading the product identification bar code during dispensing. In the event that the identification of the article dispensed from a given storage column, does not match the bar code stored in the vending machine controller for the product which should have been dispensed from that storage column, the vending machine controller operates to suspend dispensing of products from that storage column. By including a bar code reader at the product exit chute of the dispenser, it is significantly more difficult to “trick” or cheat the machine by purposefully restocking the machine with erroneous and possibly inferior product. U.S. Pat. No. 6,068,156 assigned to Adds, Inc and entitled METHOD FOR CONTROLLING A DRUG DISPENSING SYSTEM, also describes use of a bar code scanner positioned at the exit chute of an article dispenser. In this case the article dispenser dispenses medication vials. However, in this and the above noted JP4123194A2 patent, it would not be uncommon for the fixed position bar code scanner to fail to read and identify the bar codes on the articles as they roll or tumble in a haphazard manner past the bar code scanner at the exit chute.

U.S. Pat. No. 5,390,711 by Murphey entitled METHOD AND APPARATUS FOR MAKING SNOW CONES, discloses a vending machine of the type for storing articles in article storage columns. In one embodiment the columns are vertically oriented and dispense paper cups, which include a unique sequence of bar codes preprinted thereon, to a customer retrieval area where the paper cups are filled with flavored crushed ice. In an alternative embodiment, the article storage columns are substantially horizontal and the dispensing apparatus substantially comprises a spiral wire (i.e., a conventional “spiral” vending machine). In both embodiments a fixed position bar code reader is located at the dispensing end of each article storage column, for identifying the article which is about to be dispensed. In the event that the bar code of the article which is about to be dispensed is not proper or not read, the dispensing operation is automatically suspended, any money inserted into the machine is returned, and the customer is notified that the machine is now inoperative or sold out. In the event that the operator of the vending machine tries to “trick” or cheat the machine by tampering with the bar code reader or its activation, a voltage oversurge is provided to the control circuitry of the vending machine, which effectively destroys the control circuitry and renders the machine inoperative. In a manner somewhat similar to the above noted JP4123194A2, the fixed position bar code reader may have difficulty reading the article barcodes, especially if the article is improperly positioned in the storage column, such as the package being rotationally offset by 90, 180 or 270 degrees.

U.S. Pat. No. 5,713,487 by Coughlin, entitled MEDICAMENT VERIFICATION IN AN AUTOMATIC DISPENSING SYSTEM, is representative of a class of patents directed to preventing the dispensing of erroneous products (such as medication vials or video cassettes), due to improper loading of the storage area. These patents show the use of a bar code reader mounted on a computer controlled manipulator arm used for retrieving the articles from the storage area. Each stored article, or its packaging, includes a preprinted identifying bar code. When the machine controller moves the manipulator arm so as to retrieve a stored product, the bar code reader is operated so as to scan the bar code on the article, and if the bar code does not match the bar code of the article which is expected to be at that storage location (in accordance with preprogramming of the machine controller), the dispensing operation is suspended and the user of the machine is notified of a problem. If, however, the bar code is proper, the article is dispensed. It is also known that when the machine is not vending articles, the controller can operate the manipulator arm in a “checking” mode, wherein the bar code on an article storage at each location in the storage area is scanned and then checked (compared) with the article identification code stored in the memory of the controller. Improperly stored articles are thus pre-identified, and will not be dispensed. One disadvantage of these types of systems is that the bar code reader and electrical connections suffer stress due to the many cycles of manipulator arm movement, since the bar code reader is mounted on the manipulator arm. Furthermore, this kind of positioning for the bar code reader can reduce the reliability of the bar code reading device, and also introduces mechanical and electronic complexity in its construction, due to the necessity of providing electrical connections to a movable bar code reader. Even furthermore, by positioning the bar code reader on the manipulator arm, restrictions are placed upon the “view” provided to the reader as the manipulator arm is advanced toward the article to be retrieved, leading to an increase of the probability that the article bar code may not be properly read.

For completeness sake, U.S. Pat. No. 6,029,851 assigned to Imaging Technologies Ltd. and entitled APPARATUS FOR STORING AND DISPENSING ARTICLES is noted. This patent describes a dispenser for printer or toner cartridges which includes an input port for receiving used toner cartridges into the dispenser, for recycling purposes. A camera mounted at a fixed location along the input path towards the recycling storage area of the machine uses “shape/pattern recognition” to identify the returned toner cartridges. This article identification technique suffers from the same problem as before noted patents, namely that the article may pass by the article identification device in a position where it's shape/pattern can not be identified/recognized.

In the parent application to the present application, three other prior art patents, relating to videocassette vending machines which include a means for making a videocassette identification (ID), were noted, namely; U.S. Pat. No. 5,139,384 entitled ARTICLE VENDING MACHINE, U.S. Pat. No. 4,839,505 entitled METHOD AND APPARATUS FOR STORING AND RETRIEVING ARTICLES, and U.S. Pat. No. 5,273,183 entitled ARTICLE VENDING MACHINE. Each of these patents disclose techniques where the article ID is accomplished when the article is at its final (or initial) resting place, i.e., at the customer retrieval area, and not while the article is still grasped by the mechanism which removed it from the article storage area, nor while the article is still being moved by that mechanism towards the customer retrieval area.

Accordingly, one of the general objects of the present invention is to provide new techniques and methods for the design, operation and control of article handling mechanisms.

It is a further general object of the present invention to provide such techniques and methods for article handling mechanisms of the type that utilize computer-controlled electromechanical technology, and in the illustrated embodiment a robotically positioned suction-type gripper, for grasping and moving a selected article from one area to another, such as from a storage area to a dispensing area.

It is an even further general object of the present invention to provide new techniques and methods for such mechanisms which improve the speed and accuracy of the article handling operation while still handling the articles to be dispensed in a careful manner so as to prevent any damage thereto.

It is a more specific object of the present invention to provide a method and apparatus for article identification in an article handling apparatus, which not only is relatively simple, accurate and reliable in its construction and operation, but which also has some flexibility in order to help ensure identification and/or recognition of the articles being dispensed.

### SUMMARY OF THE INVENTION

The above objects are achieved in an illustrated embodiment of an article dispensing apparatus embodied, for example, as a vending machine, including a controllably positioned suction hose dispenser for retrieving articles from a storage area. In one embodiment, the article dispensing apparatus comprises a storage volume for storing a plurality of articles to be dispensed; an article extracting device including a free end for selectively grasping to and extracting an article from the storage volume; and a user interface and control apparatus for allowing a user of the dispensing apparatus to initiate an article dispensing operation, and to cause controlled movement of the article extracting device so that a selected article is extracted from the article storage area and moves along a common path to a point within the dispensing apparatus that is associated with a dispensing area of the dispensing apparatus. An article identification device, mounted at a point within the dispensing apparatus that is near the common path, is operated so as to provide identification scanning of an article while the article is still being grasped by the article extracting device and while the article is still being moved by the article extracting device, as the article moves along the common path during the dispensing operation.

### BRIEF DESCRIPTION OF THE DRAWINGS

These and other advantages of the invention will become apparent upon reading the following detailed description and upon referring to the drawings in which:

FIG. 1 is a front perspective view of a vending machine constructed and operating in accordance with the principles of the invention.

FIGS. 2 and 3 are front perspective views of the vending machine of FIG. 1, with the front door opened, so as to illustrate the main mechanical and electrical components therein.

FIG. 4 is a functional block diagram illustrating the cooperation of the main mechanical and electrical components in the vending machine of FIG. 1.

FIGS. 5 and 6 illustrate details of the carriage portion of article handling mechanism shown in FIGS. 2 and 3.

FIG. 7 illustrates details of the hose guidance mechanism shown in FIGS. 2 and 3.

FIGS. 8, 9, 10, 11 and 12 illustrate combinations/orientations of various article handling mechanisms and storage areas.

While the invention will be described in conjunction with the illustrated embodiments, it will be understood that it is not intended to limit the invention to such embodiments. In the contrary, it is intended to cover all alternatives, modifications and equivalents as may be included within the spirit and scope of the invention as defined by the appended claims.

### DETAILED DESCRIPTION OF PREFERRED EMBODIMENTS OF THE INVENTION

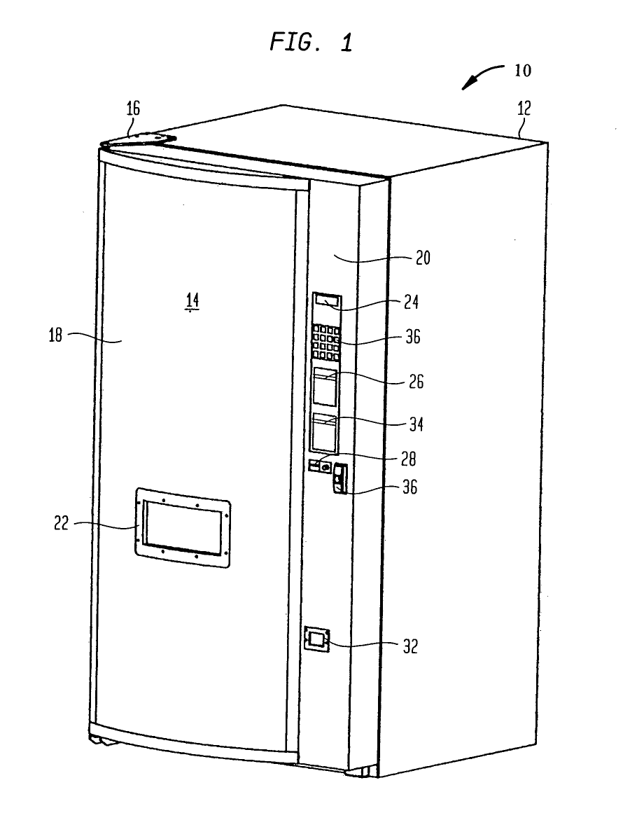

FIG. 1 illustrates an environment for the invention described herein, in the form of an article dispenser, such as a point-of-sale (POS) dispenser. Although throughout the following description, reference is made to implementation of the invention in a vending machine environment, it is intended that the term “vending machine”, and in fact the environment for the present invention, include more general purpose article handling, retrieval and/or dispensing apparatus, as well as POS equipment. Such equipment, if embodied as a portable device may comprise and be about the size of a traditional vending machine or as large as a tractor-pulled trailer, and if embodied as a non-portable device may comprise and be embodied as an automated dispensing room or an area located in a permanent structure, such as in a building (aboveground or underground, and with or without interior walls or an enclosing cabinet). Furthermore, it is intended that the term “articles” or “products” include in at least some of the embodiments of the invention described herein, not only goods, but also services and/or information, in either a permanent or temporal form.

Accordingly, FIG. 1 illustrates a perspective view of a vending machine 10, comprising one embodiment for an apparatus which is constructed and operates according to the present invention. Vending machine 10 includes a main cabinet 12 and a front door 14 mounted on a hinge 16 for providing access to the interior of the vending machine for servicing (refilling it with articles, maintenance, etc.). Note, in a further vending machine embodiment, a service door or port could be positioned anywhere on or as a part of cabinet 12. In FIG. 1, front door 14 is shown in a closed position, forming an enclosure with main cabinet 12, within which various components of vending machine 10 are housed, as explained in more detail below.

Front door 14 includes a convex-shaped section 18 adjacent a flat section 20; however, these particular shapes are not necessary to the invention. The convex-shaped section 18 comprises a translucent plastic display panel 18, which typically has brand name and/or logo graphics displayed thereon, and may even include graphics which illustrate the individual articles that are vendible by vending machine 10, as well as the price and/or selection information for the articles. Panel 18 is typically back-light using fluorescent bulbs, not shown.

A customer retrieval area 22 is formed in the panel 18 on door 14 so that articles stored therein can be discharged to a user of vending machine 10.

Various user interface components are mounted on flat section 20 of door 14. A customer display 24 may be a conventional fluorescent or LED display panel for displaying various items of information to a user of machine 10, such as feedback to the user of the selection made, the amount tended, and if the product is sold out or being vended. For accepting payments, a bill acceptor slot 26 accepts paper money into a conventional bill acceptor mechanism (mounted inside machine 10 so as to have its user interface portion extend through an aligned opening in flat section 20) for purchasing articles or for making change. A coin insertion slot 28 accepts coins into a conventional coin changer (also mounted inside machine 10 so as to have its user interface portion extend through an aligned opening in flat section 20) for purchasing articles or for making change. A coin return actuator 30 comprises a conventional push-button mechanism for activating a coin return portion of the coin changer mechanism which, upon actuation returns coins inserted by the current user, to a coin return well 32. The coin return portion of the coin changer mechanism also provides change to the coin return well 32 either in response to the purchasing of articles or for making change for paper money or larger coins. A credit/debit card slot 34 accepts a plastic credit/debit card inserted into a conventional card reader mechanism (also mounted inside machine 10 so as to have its user interface portion extend through an aligned opening in flat section 20) for allowing a user to pay for purchases via credit/debit cards. A door lock mechanism 36 enables front door 14 to be secured so that it cannot be opened without a key. For allowing user selections, display panel 18 may include graphics, as noted above, which indicates the various articles vendible by the machine, as well as their associated price and unique selection number. Alternatively, flat section 20 could include a group of graphic article displays and their associated price. A conventional keypad push-button mechanism 38 is provided for enabling a user to select a desired article from vending machine 10. Alternatively, push-button mechanism 40 could include individual push buttons for each article selection, as well as an associated price display; and even furthermore, a user operated touch screen could replace pushbutton mechanism 40 and display 24. Although not shown in FIG. 1, machine 10 also includes a conventional telecommunications component that can be used for authenticating credit card purchases, as well as other uses relating to machine control and reporting the inventory and operational status of machine 10 to a remote location, as more fully described later on. Although vending machine 10 is illustrated to include the above described user interface components, in a more minimal embodiment of the invention, most, if not all, of these user interface components could be omitted, and the dispenser could in fact be controlled from a remote location, with or without a local payment system.

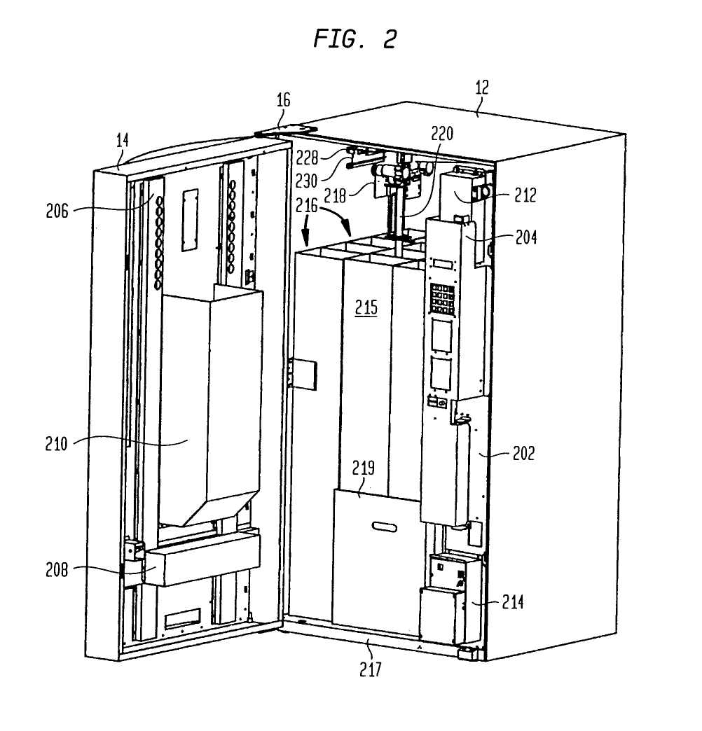

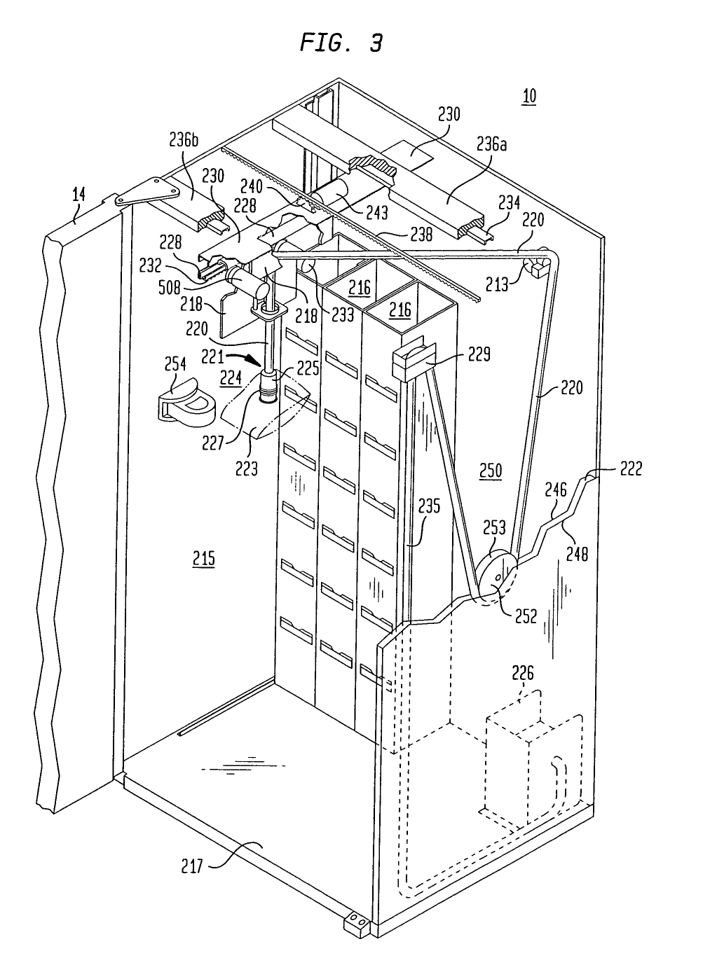

FIG. 2 is front perspective view of the vending machine of FIG. 1, with the front door open, so as to illustrate the main mechanical and electrical components therein. FIG. 3 is a somewhat idealized version of the main components of the article handling mechanism portion of vending machine 10, and is useful for understanding its general operation. Note, some portions of vending machine 10 are shown in these FIGURES cut away in order to better illustrate the interior components.

Referring first to FIG. 2, it is noted that the right portion of the front of cabinet 12 includes a vertically mounted support panel 202 which is used for mounting most of the user interface components. More specifically, a hinged mounting bracket 204 is mounted on panel 202 and aligned with an opening in door 14 so that the user interface components, such as the selection button keypad 40, coin insertion slot 30, bill acceptor slot 28, coin return 32, and customer display 24, are all accessible to the user from the front side of door 14. Mounted on the interior of front door 14 are two fluorescent bulb light sources which emit light for backlighting panel 18. The fluorescent bulb light sources are behind protective covers 206 so as to provide security (vandal protection), which is desirable as a result of the openings in the structure of door 14 which allow for insertion of the fluorescent bulbs. Also mounted on the interior of front door 14 is a ballast 208 for the fluorescent bulbs, and a product delivery chute 210 . . . . Note, the product delivery chute 210 is unconventional in that it is extremely tall, and therefore serves as a security measure to prevent unauthorized access into the machine by insertion of an arm or other grasping mechanism into the customer retrieval area 22 from outside the machine. In typical prior art vending machines, a swinging security door is usually found at the top of chute 210, which swings into in a vandal blocking position when the customer pushes in the swinging door at the entrance to the product retrieval area 8. In a further embodiment of vending machine 10, such a swinging security door could be used in conjunction with product delivery chute 210, especially if chute 210 is not as tall as the one illustrated in FIG. 2 and also if the product retrieval area 22 is located higher up on machine 10. Mounted behind hinged mounting bracket 204 is a conventional bill acceptor mechanism for causing paper money inserted into bill acceptor slot 28 to be drawn into vending machine 10, a conventional coin changer supplies coins to coin return slot 34 and is located behind panel, a coin guide guides inserted coins into the coin changer, and a conventional bill validator ascertains proper insertion of paper money into bill acceptor slot 28.

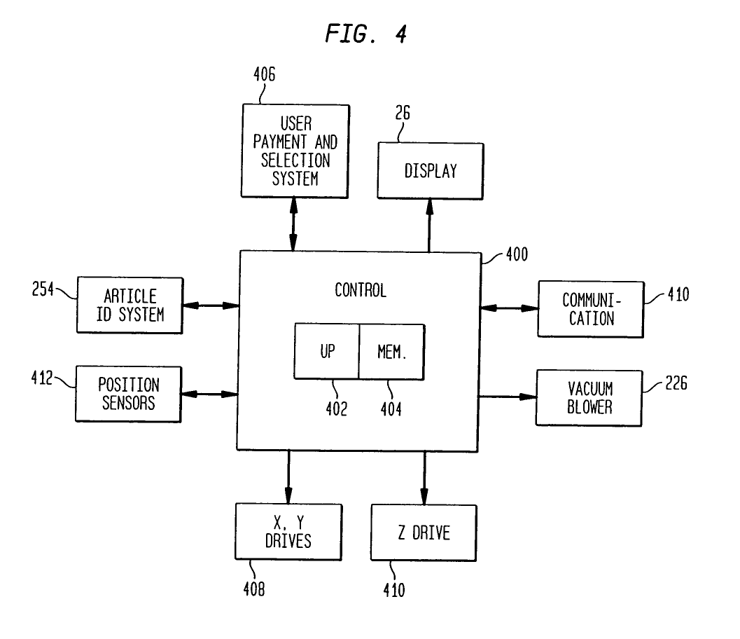

A control board 212 comprises a printed circuit board on which circuitry is formed and to which integrated circuit chips are attached. Control board 212 includes a microprocessor that is electrically connected to various sensors, motors, the above described user interface elements, as well as other devices within vending machine 10, to control the operation of vending machine 10 as described more fully later on in conjunction with FIG. 4. When reference is made in this description to performance of specified functions by control board 212, it is to be understood that these functions are controlled by the microprocessor and the associated circuitry formed on control board 212. A power supply 214 is mounted on panel 202 and supplies power for the electrical components of vending machine 10.

Referring now also to FIG. 3, it is apparent that the bulk of the interior of cabinet 12 is available as an article storage area 215. In the illustrated embodiment, a plurality of vertically aligned article storage bins 216 are arranged on the interior floor 217 of cabinet 12, for storing articles 223 to be vended by machine 10. In a refrigerated environment for the present invention the bins could be arranged to sit on a shelf positioned above the refrigeration system.

An opened-top container 219 can be dimensioned to hold a plurality of article storage bins 216 therein, and used, for example to facilitate the simultaneous handling (i.e., removal, installation and transportation) of the plurality of bins 216 into/out of the article storage area 215. Container 219 also facilitates rapid and accurate positioning of a plurality of the article storage bins into the storage area of the article handling apparatus. A carriage 218 (which may be more generally referred to as an X-Y or planar positioning mechanism) is coupled to the interior topside of cabinet 12 and adapted for being controllably positioned by the control board portion 212 of machine 10, to a location centered over (so as to be aligned with) the open top-end of a selected one of article storage bins 216.

Although vertical (Z-axis) alignment of the article storage bins 216 is shown, non-vertical, i.e., slanted or even horizontal (X or Y axis) alignment may also be possible (such as found in the well know glass front vending machines of the type using a “spiral wire” type of dispensing apparatus). In the event of substantially horizontal alignment of the storage bins, the planar positioning mechanism will be appropriate changed so as to position carriage 218 for movement in the X/Z or Y/Z plane. In fact, a curvilinear plane, such as a cylinder, is also considered to be within the scope of the present invention. The combination of substantially horizontally aligned stacks of products with a robotically controlled article transport mechanism which moves in a vertical plane adjacent to dispensing ends of the stacks of products, is known, for example in U.S. Pat. No. 6,230,930 issued May 15, 2001 and entitled METHOD AND APPARATUS FOR VENDING PRODUCTS, and in US patent publication U.S. 2001/0000609 published May 3, 2001. Use of a curvilinear plane for article transport is known, for example in the videocassette vending art, wherein the videocassette's are stacked in an outwardly facing manner in a central storage carousel, and a robotic gripper encircles the carousel. Furthermore, although article storage bins 216 are shown to be an ambient environment, bins 216 could in fact the positioned in a refrigerated environment, such as a freezer located in the bottom of storage area 217, and the article transport mechanism enter the bins from a top opening the freezer, such as shown and described in the forenoted U.S. Pat. No. 5,240,139. Alternatively, in the event the refrigerated environment is of the type including a substantially horizontal alignment of the storage bins, a vertically oriented opening could be used to provide access to the dispensing end of the article storage bins.

In the environment of the present invention, an air hose 220 is continuous from a point before it's exit from a hose storage area 222 over orthogonally positioned rollers 213, to its free end 221. Free end 221 includes a weighted portion 225 in combination with a bellows extension tip portion 227. Depending upon the physical characteristics of the articles to be dispensed, article pickup head 224 may comprise only the weighted portion 225, or this portion in combination with a fitting specifically adapted to the type of packages to be dispensed, such as the bellows tip 227 or a compliant tip without a weight. Hose 220 has one end coupled to a source of negative air pressure, i.e., suction, which source of suction comprises in the preferred embodiment a blower motor 226, and a free end coupled to the article pickup head 224. In the present invention, the word continuous is intended to mean a hose which is connected and acts between it's end points, in order to accomplish the functions required by it, as a unitary/single hose. An air hose portion 235 provides suction from blower motor 226 to one port of an air junction box 229, while continuous hose 220 is connected to a second port of air junction box 229. Air junction box 229, included at a top portion of hose storage area 222, includes an airflow sensor and vacuum breaker assembly. The airflow sensor is used to develop a signal which is applied to the controller of the vending machine and is representative of the airflow through air hose 220. The vacuum breaker assembly is used to quickly bring the air pressure in hose 220 to the ambient pressure, thereby facilitating a “quick-release” of an article transported by the article pickup head, into the dispensing chute 210. It is noted that a quick release of the products does not have to occur at the top of dispensing chute 210, and in the event that it is desirable to avoid subjecting the article to forces which result from jarring or dropping, the article pickup head could proceed to the bottom of the dispensing chute 210 before providing the quick release of the article. In one embodiment, the airflow sensor arrangement may comprises a two-part switch, a first part includes a reed switch mounted on a top portion of box 229, and a second part includes a magnet mounted at the free end of a swinging arm mounted inside box 229. As the arm swings inside box 229 due to changes in airflow, the switch is “toggled”, thereby indicating changes in airflow. The use of this airflow signal will be described in greater detail later.

In the environment of the present invention, as shown generally in FIG. 3, a novel hose positioning arrangement is provided for aligning carriage 218 with a selected one of bins 216. This alignment is accomplished in the front/back (Y) direction using a front/back linear slide 228 (shown in a cut away view) mounted to an “L” shaped front/back beam 230 so that carriage 218 can be controllably positioned therealong using slide 228. A bottom edge portion of beam 230 includes a rack portion 232 and carriage 218 includes an electric motor 233 and gear (not shown) which engages rack portion 232. Application of forward and reverse motor control signals from control board 212 to motor 233 causes carriage 218 to be driven in the front/back directions. Alignment of carriage 218 in the left/right (X) direction is accomplished in a similar manner, using a left/right linear slide 234 which slidably couples the top side of front/back beam 230 to the underside of each of spaced apart left/right beams 236a and 236b. Beams 236a and 236b are rigidly attached to the inside top portion of cabinet 12. A rack 238, also rigidly attached to the top inside portion of cabinet 12 and in parallel with beams 236, is engaged by a gear 240 driven by a reversible motor 243 mounted near the inside corner of beam 230. Application of forward and reverse motor control signals from control board 212 to motor 243 causes a rotation of gear 240 and a corresponding movement of beam 230, and hence carriage 218, in the left/right (X) directions. In an alternative embodiment the positioning mechanism portion comprising beams 236a and 236b could be embodied as a support bracket having opposed flanged edges, and linear slides 234 could each comprise a bracket fixed to beam 230 and including a set of orthogonally positioned rollers for engaging the orthogonal sides of a respective one of flanged edges 239a or 239b.

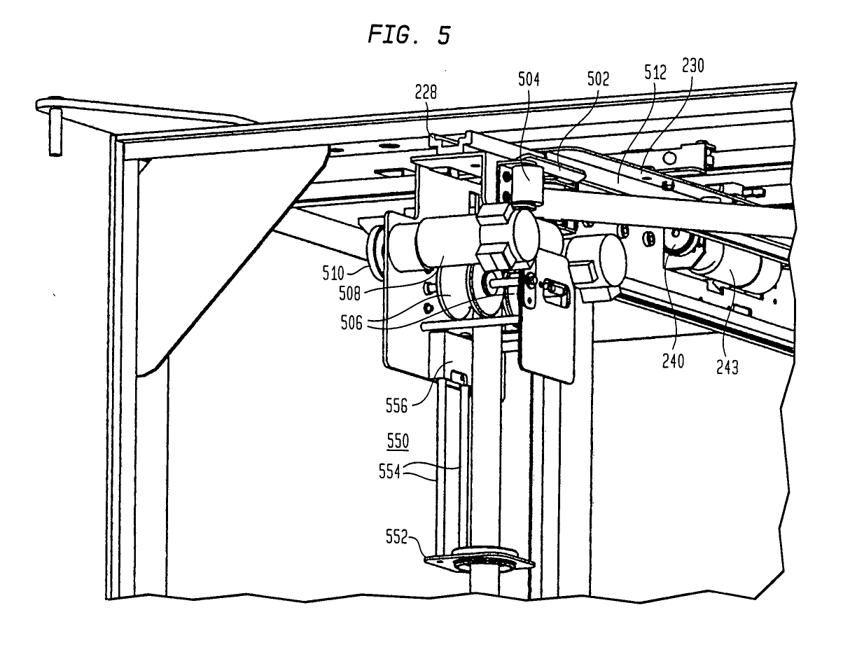

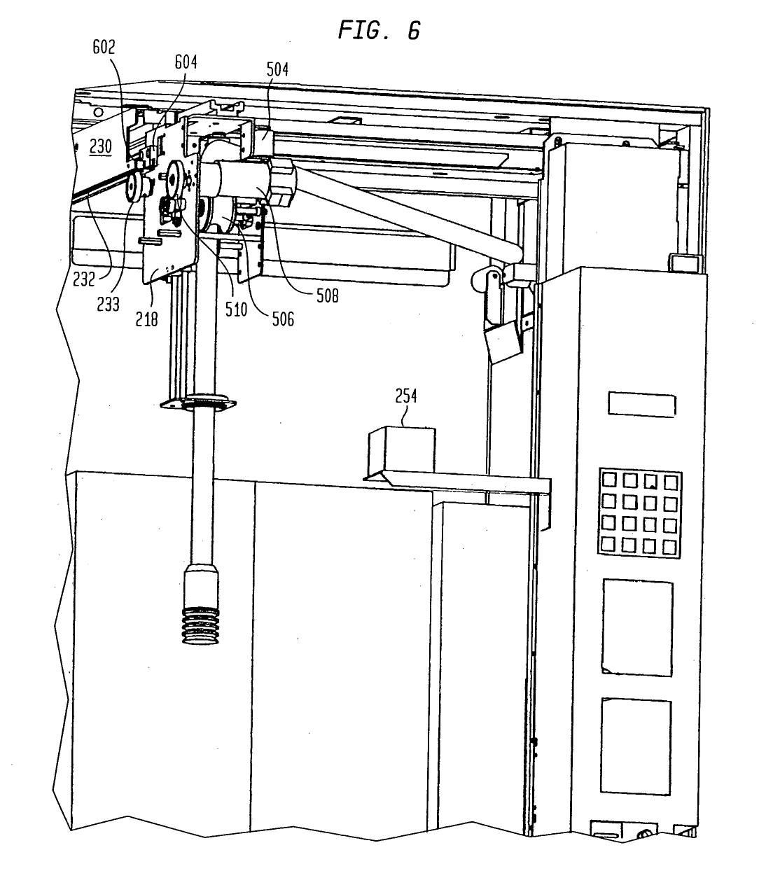

Note that although carriage assembly 218 only moves in a single plane, it is responsible for precisely positioning pickup head 224 in each of the X, Y and Z directions. More specifically, as shown in FIGS. 5 and 6, carriage 218 includes a roller arrangement 502 which comprises three orthogonally positioned rollers 504 at the point where hose 220 enters carriage 218, for redirecting the movement of hose 220 from a substantially horizontal direction along the top interior portion of machine 10 (i.e., in the X,Y direction), to a direction perpendicular thereto (i.e., in the Z direction). Movement of carriage 218 will not only move the free end 221 of hose 220 so that it can be axially aligned with a selected one of bins 216, but it will also automatically withdraw hose 220 from the hose storage area 222. Thereafter, a hose drive mechanism which may comprise a set of conventionally operated “pinch rollers” 506 driven by a reversible motor 508 via gear set 510 (which in the illustrated embodiment are mounted in carriage 218, but in a further embodiment motor 508/rollers 506 (or some other drive mechanism, such as an articulated arm, could be mounted so as to act somewhere else along the length of hose 220) is used for driving pickup head 224 into/out of the selected bin 216 in order to retrieve articles stored therein.

This arrangement, where hose 220 travels in the same X,Y plane that carriage 218 travels, facilitates a compact hose positioning and drive mechanism embodiment for the present invention. Furthermore, since movement of the carriage is responsible for supplying most of the force needed to withdraw hose 220 from storage area 222, the Z drive motor is only needed to drive the hose for causing its free end to travel into/out of bins 216 for article retrieval. It is noted that the pinch rollers 506 should comprise a soft rubber material so as to provide a good friction contact to hose 220, and if the hose 220 is corrugated, rollers 506 could have corresponding/matching corrugations. In the illustrated embodiment, it has been determined that two drive rollers are not needed, and accordingly only one of the pinch rollers is driven by motor 508, while a spring (not shown) is used to urge the other roller towards the driven roller, thereby pinching and driving hose 220 therebetween.

A bin holder 260, shown in FIG. 2, comprising a pair of rectangular brackets secured in a spaced manner to opposed interior side walls of cabinet 12, is used to maintain the bins situated therebetween in a predetermined position relative to the interior of the vending machine cabinet. This is required in view of the pre-programming of control board 212 which controls the robotic structure for retrieving a selected article from one a selected one of bins 216.

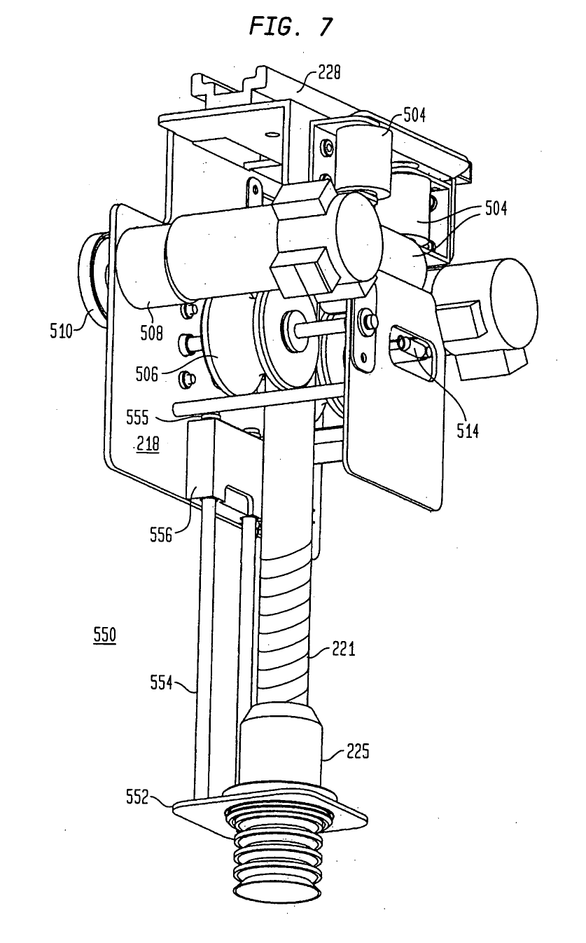

Also shown in FIGS. 5 and 6, and in greater detail in FIG. 7, is a telescoping guide mechanism 550 for ensuring that when picker head 224 is lowered by the drive mechanism in carriage 218 into the storage area, it drops into the desired one of bins 216. For example, depending upon the material used for constructing hose 220, it is possible that during long time periods when hose 220 is not repositioned, the 90° turn in the direction of the hose which takes place in carriage 218 can form a significant “kink” in hose 220. Thereafter, as hose 220 is lowered into a selected bin 216, the kink may cause picker head 224 to swing as the hose kink moves past drive rollers 506. In order to prevent such undesired swinging or movements of picker head 224, guide mechanism 550 is provided and comprises a guide plate 552 affixed to the end of two sliding support bars 554. As shown more clearly in FIG. 7, support bars 554 slide through holes in a plastic (PVC, i.e., poly vinyl chloride) block 556 secured to a wall portion of carriage 218. Plate 552 is constructed so as to have a hole in the center thereof which is dimensioned to be slightly greater than the diameter of the body portion of picker head 224, yet less than the diameter of a shoulder portion thereof. Accordingly, in operation when picker head 224 is lowered into a desired bin, support rods 554 allow support plate 552 to drop, due to gravity, as the same speed as picker head 224 is lowered away from carriage 218. At a height above the top of bins 216, and as determined by the length of support rods 554, plate 552 no longer moves away from carriage 218 and the hole in the center thereof merely provides guidance for the remainder of the descent of picker head 224 into the selected bin 216. As picker head 224 is retracted from the bin, after having a package secured thereto due to the suction force created within hose 220, picker head 224 eventually contacts guide plate 552 and then for the remainder of its upward travel, retraction of hose 220 also provides for retraction of guide plate 552.

As shown more clearly in FIG. 7, support rods 554 comprise rods having a threaded hole at each end, in which a machine screw can be inserted. At the top portion of rods 554 the head of the screw forms a shoulder portion that prevents rods 554 from falling completely through the holes in block 556, and at the bottom of rods 554 the screws secure plate 552 to the rods. As also shown in FIG. 7, plate 552 includes a protective grommet about the hole therein, for preventing damage and reducing wear of hose 220 as it travels through plate 552. It is noted that the height of grommet is preferably greater than the spacing between adjacent turns of the spiral support structure of hose 220. Furthermore, it is noted that hose 220 is preferable constructed of a strong, flexible spiral portion functioning as the spine to form the shape of the hose, formed co-extensively with a flexible and air-tight plastic material which spans adjacent turns of the spiral portion.

As previously noted, since hose 220 is formed of a continuous material from its connection to the source of suction at one end to the pickup head 224 at its other end, means are necessary for providing hose storage and/or retraction during travel of the pickup head 224 in the X, Y and Z directions, as appropriate during the article dispensing operations.

Accordingly, as shown in FIG. 3, placing an interior wall 246 parallel and adjacent to an exterior wall 248 of cabinet 12 is used to form the hose storage area 222 there between. Hose storage area 222 has a cross-sectional area which is slightly greater than the cross-sectional area of the hose loop formed therein. Walls 246 and 248 are shown partially cut-away so as to illustrate a gravity feed self-retracting loop tensioner/retraction mechanism 250 formed in hose 220. Loop tensioner 250 is constrained for movement within hose storage area 222, and made somewhat self-retracting by comprising a rolling weight 252 having a groove 253 along its periphery in order to provide constant centering of the weight within hose storage area 222 and for providing a constant “loop forming” tension on hose 220. Furthermore, centering of the grooved rolling weight 252 within hose storage area 222 results in centering of hose 220, thereby preventing hose 220 from rubbing with the walls of hose storage area 222 during X, Y and Z repositioning of pickup head 224. In order to prevent binding of hose 220, rolling weight 252 is dimensioned so as to be slightly larger than the diameter of hose 220 and the width dimension of hose storage area 222 is dimensioned to be only slightly larger than the width dimension of rolling weight 252. The specific amount of weight used for rolling weight 252 is a matter of design choice, and depends upon various factors, such as the weight of the articles to be moved, the strength of the motors used to drive the hose in the Z direction, etc. In a further embodiment, it may be desirable to couple weight 252 to a lower portion of cabinet 12 using a spring, for adding further tension to loop tensioner 250.

It is also noted that this gravity-based retraction/hose storage technique meets the storage requirements needed for both the X and Y movements of carriage 218 (left/right and front/back), as well as for the Z movement of pickup head 224. Of course this gravity-based retraction/hose storage technique would work equivalently well in an embodiment wherein the robotic hose positioning mechanism used a rotary type device (R, θ), an articulated arm, telescoping or scissor system, or other technique. Furthermore, the illustrated gravity-based retraction/hose storage technique is not necessary for the present invention, and in fact a fully or partially motorized retraction technique could also be used. Furthermore, in other embodiments, it may be desirable to place hose storage area at another location, such as parallel to the top or rear portion of cabinet 12.

In accordance with the principles of the present invention, and as shown more clearly in FIGS. 2 and 3, as an article 223 is moved by pickup head 224 along its way from a storage bin 216 to chute 210, it is positioned past an article identification (ID) device 254 mounted within cabinet 12. A specific type of article ID device is not required for the present invention, and depending upon system constraints, such a device may comprise, for example, a bar code scanner or other optical image/pattern recognition system, or even a non-optical system, such as a radio frequency identification (RFID), or magnetic-based system mounted within cabinet 12. for uniquely identifying and confirming that the article being dispensed is in fact the article that was selected. The construction operation of such article identification devices are well known to those of ordinary skill in this technology, and therefore further description in this regard is not necessary.

In accordance with an inventive aspect of the present invention, article ID device 254 is mounted within cabinet 12 at a relatively fixed location, the mounting being such that some controlled movement in the orientation of article ID device 254 may be facilitated, in order to help ensure a good “view” of the article being transported, and a high confidence of the transported articles being identified. One way to provide such controlled movement for ID device 254 would be to mount it on a piezoelectric substrate, and control board 212 could provide a voltage to the substrate so as to shift the “view” of ID device 254. It is noted that by using an appropriately positioned article ID device 254, only a single article ID device 254 is needed. This is particularly useful for a robotic type dispenser, since the robotic apparatus can controllably position, and re-position if necessary, the article in the vicinity of the article ID device 254, thereby helping ensure a reliable ID of the article.

Furthermore, although in FIG. 3 product ID device 254 is mounted to an interior wall of cabinet 12, it is noted that FIG. 6 illustrates a further preferred location for mounting product ID device 254, namely on the inside edge of hinged bracket 204, and just above the top of bins 216.

Alternative embodiments for the robotic mechanism described above are contemplated to be within the scope of the present invention. For example, product ID device 254 could also be useful in dispensing apparatus using other types of robotic positioners, such as a rotary type device (R, θ), an articulated arm, telescoping or scissor system, etc., as well as one which travels in a non-planar, such as curvilinear, direction.

Even furthermore, although only a single storage area 215, hose 220 and carriage 218 are shown in the illustrated embodiment, the invention described herein could also be used in a dispensing apparatus/article handler of the type having multiple storage areas and/or robotic article handling mechanisms, such as two robotic mechanisms (both positioned vertically or horizontally or mixed, and one vertically and one horizontally) each one serving a different storage area. Furthermore, when multiple article handling mechanisms are provided, each can be tailored for a particular operation. For example, one may have a relatively large diameter pickup head and use a high airflow/modest suction vacuum supply device, while the other may have a relatively small diameter pickup head and use a low airflow/high suction vacuum supply.

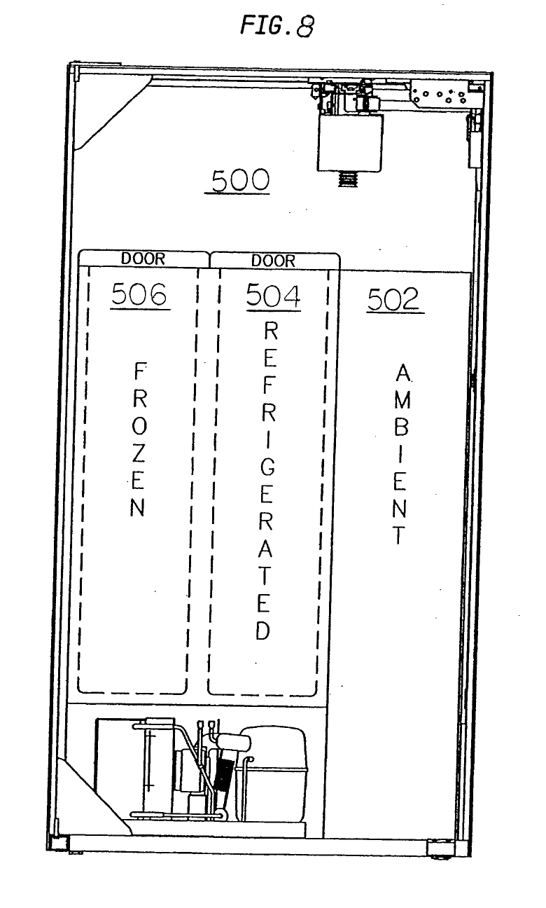

In this regard, FIG. 8 illustrates a multiple storage area arrangement 500, where a single article handler of the type previously noted serves 3 adjacent storage areas. In one embodiment each area may be for storing stacks of articles aligned in the same direction as in the other areas. One storage area 502 may have an ambient environment, while the other storage areas may be cooled, e.g., one area 504 being refrigerated and one area 506 being frozen. This arrangement may typically find use for dispensing in a compact, reliable and efficient vending structure: salty snacks (such as bags of potato chips) from the ambient storage area, cooled drinks (such as soda) from the refrigerated storage area, and frozen snacks (such as ice cream) from the frozen storage area. Furthermore, an arrangement of this type may be particularly advantageous in that the frozen compartment can be used for maintaining the quality of the stored articles until they are close to being needed for dispensing, as determined by an intelligent controller. At a predetermined appropriate time before dispensing, a certain amount of articles can be moved from the frozen area to the refrigerated area. This technique also finds particular advantage in the event that the third storage area is in fact a temporary storage area which is used for individually heating/cooking the articles, such as, e.g. frozen pizzas, using an oven or microwave. In this case the quality/shelf life of the frozen pizza is maintained by not moving them to the refrigerated area until the refrigerated area has been depleted to the point that it needs replenishment, at which time they are sequentially moved from the frozen area to the refrigerated area. This technique substantially reduces the time needed for heating the pizza while the customer is waiting, while at the same time allowing for storage of the pizza in a frozen manner, thereby substantially increasing its shelf life and reducing the labor costs involved in stocking the machine. In this arrangement, or other arrangements noted in this portion of the description, the refrigerated and/or frozen storage areas can include thermal separators at their top portions, such as an air curtain or sliding thermal panels. Such separation is particularly advantageous not only for the obvious reasons relating to thermal efficiency and protection of the mechanical and electronic portions of the apparatus from extreme and rapid temperature changes, but also for assisting/facilitating reliable article identification, by positioning the article identification device(s) outside the refrigerated environment.

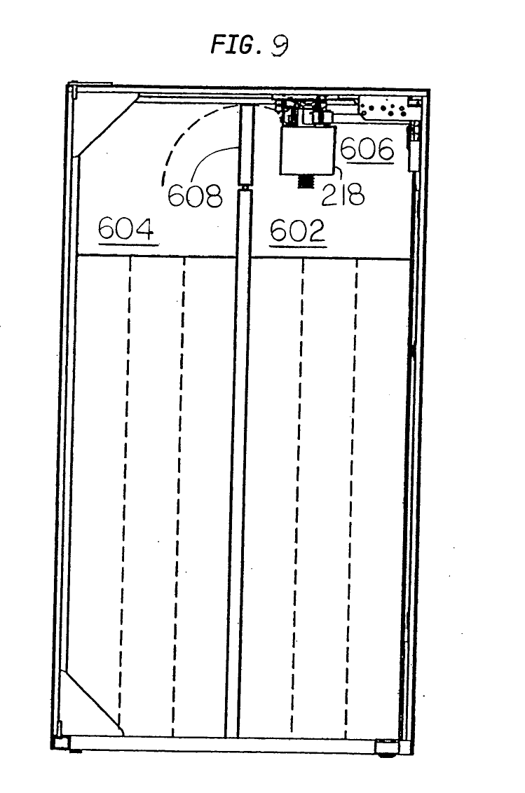

FIG. 9 illustrates an arrangement where the single article handling mechanism services two horizontally aligned in article storage areas. Area 602 being an ambient environment and area 604 being a refrigerated environment. The article handling mechanism 606 can be constructed in a manner such as previously described using support beam 230 and carriage 218 so that mechanism 606 can “live” in the ambient area 602, and travel into the refrigerated area 604 through swinging door 608 as needed. Areas 602 and 604 can each include their own article ID device 254 or share a common ID device.

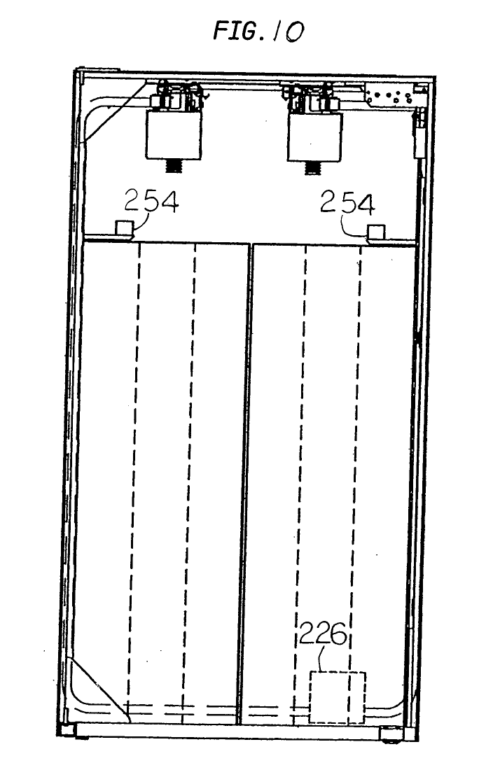

Additionally, separate hoses and hose positioning mechanisms can also be useful in order to speed up retrieval and delivery of stored articles to a customer. FIG. 10 shows such as a rapid article dispenser, of the type having two horizontally displaced storage areas. Although separate hoses and hose positioning mechanisms are used, they may share a single source of suction (e.g., blower motor 226), airflow sensor and vacuum breaker. In accordance with the principles of the invention, each robotic article handling mechanism could have its own article ID device, or they could share a single article ID device.

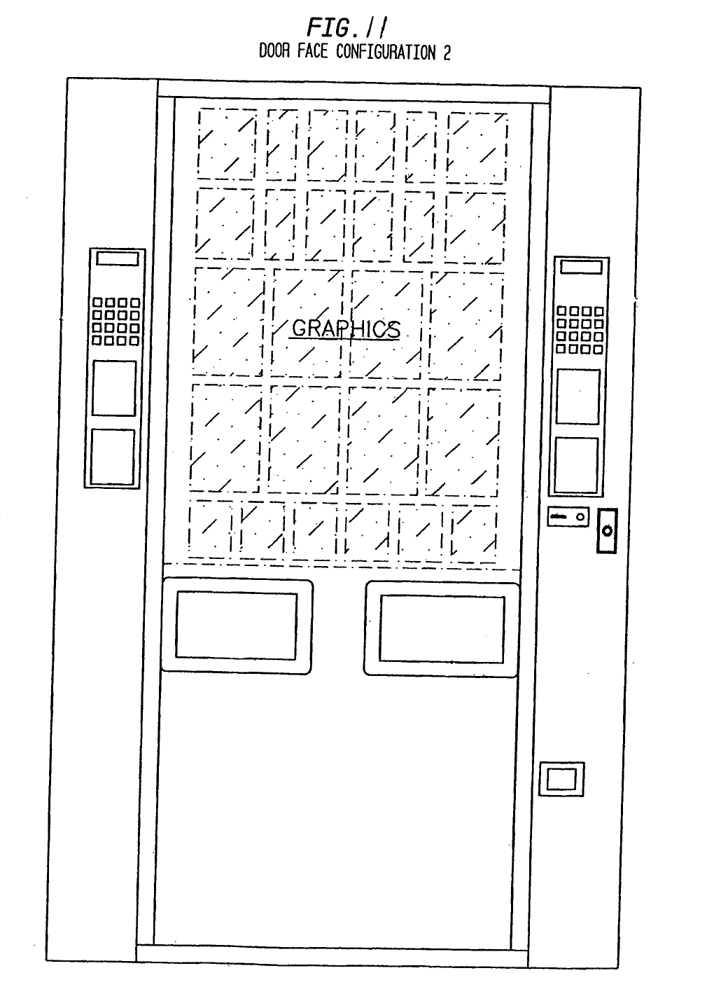

FIG. 11 illustrates a vending machine having a single article handling mechanism with dual customer interface areas (each including a product selection apparatus such as a keypad or touch screen, payment system, and product retrieval door), for example, one on the left side and one on the right side, with a common graphics display therebetween. This machine can service two purchasers at substantially the same time since customer selections and payment typically take a substantial amount time compared to the actual time needed for the dispenser to deliver the selected product.

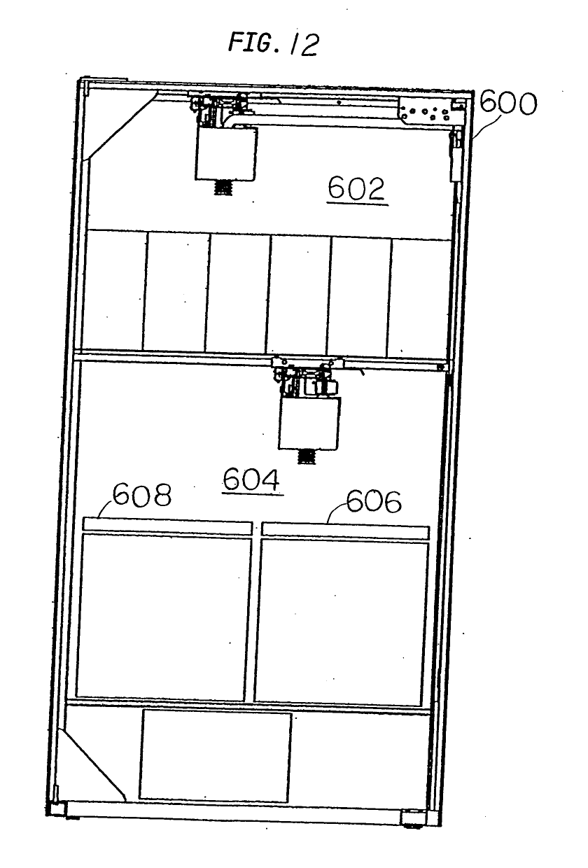

A further one of such arrangements is shown in FIG. 12, where cabinet 600 includes therein an upper area 602 which is non-refrigerated (and may even be heated) and a lower area 604 which is refrigerated (and may even be divided into, e.g., two additional sections, one area 606 being frozen and another area 608 being merely cooled). This arrangement is particularly advantageous since hot air tends to rise and cool air tends to sink. Alternatively, one storage area may be oriented for vertical storage of products and the other one, or even multiple ones, arranged for horizontal storage. In this case a separate hose, hose positioning mechanism and hose storage area may be required for the differently oriented storage areas.

In the above arrangements it is noted that the article handling mechanism can have other configurations such as the forenoted telescopic tubing, scissors, or R, theta arrangement. Additionally, the articles can be consumer goods, such as office supplies, printer cartridges etc.

In the embodiment illustrated herein, blower motor 226 provides a relatively high volume of airflow but a relatively modest negative air pressure. As a matter of design choice, blower motor 226 could comprise a vacuum pump, so as to provide a much more substantial degree of negative air pressure, but, due to size and cost limitations, a correspondingly reduced amount of airflow. In this latter case, the diameter of the air hose 220 would be reduced from the diameter illustrated in FIGS. 2 and 3, which may be particularly important in some applications of the present invention. The illustrated embodiment is particularly useful for picking up flexible packages since a momentary or even sustained leak in the coupling to the packaging to the article will generally not result in dropping of the package, while at the same time offering extreme versatility due to the ability to pick up a wide variety of shaped objects of varying weight and size. In the event that blower motor 226 comprises a vacuum pump, it could be used alone or in combination with a storage tank coupled to the suction hose via a valve and air hose, in order to provide a greater volume of airflow. Alternatively a compressor could be used in combination with a venturi device to create a vacuum.

Alternative embodiments for the robotic hose positioning mechanism described above are contemplated to be within the scope of the present inventions. For example, instead of using a combination of left/right slides 234 and support beams 236a and 236b, a roller/guide rail combination could be used. Support beams 236a and 236b may comprise a support plate having two outwardly facing, i.e., opposed, L-shaped rails, along its edges. The function of slides 234 could be accomplished by fixing a pair of brackets to opposed ends of beam 230, each bracket including a pair of spaced apart and inwardly facing rollers which engage and follow the opposed rails on the support plate. Furthermore, the spaced apart and inwardly facing rollers could each comprise a set of rollers positioned to be angled 90 degrees with respect to each another, so as to engage or follow the two orthogonal surfaces of the L-shaped rails. Such arrangement may result in a coupling of carriage 218 to beam 230 which needs less adjustment for proper operation. Furthermore, as previously noted, the event of substantially horizontal alignment of the storage bins, the robotic hose positioning mechanism can position carriage 218 for movement in a vertical plane which is substantially flat (i.e., in the X/Z or Y/Z plane) or in fact a vertical curvilinear plane. Additionally, as previously noted, in some aspects of the invention, it may be desirable for the robotic hose positioning mechanism to include a rotary device (R, θ) of the type including an I beam of fixed length (or telescopic sections), for establishing the “R” movement of the gripper/pickup head, which pivots for establishing the “θ” movement. Alternatively, in other environments for the invention the robotic hose positioning mechanism may include an articulated arm or scissor system, or other technique.

FIG. 4 illustrates a functional block diagram of the general operation of the various aspects of the invention described herein, as embodied in an article dispenser of the type comprising, for example, vending machine 10. A control system 400 including a microprocessor 402 and associated memory circuits 404, is constructed on control board 212. Control system 400 may also include the electronic parts of other portions of vending machine 10, as appropriate. Memory circuits 404 include ROM for storage of operating programs (embedded software, as well known, for accomplishing the described herein control of vending machine 10), as well as RAM cache for temporary storage of operational data during system operation as well as other data as may be needed. Control system 400 is responsive to user operation of the user payment and selection system 406 (including the coin and bill mechanism 28 and 30 and the selection buttons 40 of FIG. 1) for operating the user interface and article handling apparatus of vending machine 10 so as to dispense the article desired by a user. More specifically, upon proper payment for a selection made by the user using payment and selection system 406, control system 400 operates the X/Y (left/right and front/back) drive motors 233 and 243 so as to position pickup head 224 to be in alignment with a bin 216 which holds the article selected by the user. Control system 400 then engages a hose drive motor 508 (Z-motor) mounted within and carried by carriage 218, so that hose 220 is driven in a direction towards the top article in the aligned bin. At an appropriate time before head 224 contacts the article to be removed (and in an embodiment of the invention where cabinet 12 does not include refrigerated air, an appropriate time may be just before head 224 enters bin 216, but if the air is refrigerated, just before contact with the desired article is expected, in order to minimize removal of refrigerated air), control system 400 activates blower motor 226 so as to provide lifting suction at pickup head 224. Upon position sensors 412 determining that pickup head 224 has contacted and become secured to the desired article, control system 400 causes hose drive motor 410 to reverse its direction so as to retract hose 220 from the aligned bin 216 and thereby lift out from the bin 216 the selected article. Carriage 218 is then driven to a position in alignment with the article delivery chute 210.

Upon sensors 412 sensing alignment of carriage 218 with chute 210 (in this case sensor 412 may comprise a reed switch mounted on a front wall of the cabinet, and a magnet mounted at a leading edge of carriage 218), control system 400 turns off blower motor 226 and the resulting loss of vacuum causes the selected article to drop into the customer retrieval area 22. As previously noted, in the event that the articles are so fragile that they should not be dropped or subjected to such impact forces, hose 220 can be driven to the bottom of chute 210 before the article is released.

It is noted that position sensor 412 may include the airflow sensor of junction box 229, or in a further embodiment, comprise a mechanically operated plunger-type position sensor associated with pickup head 224. Even furthermore, position sensors 412 may also include a reed switch mounted on a front wall of the cabinet, and a magnet mounted at a leading edge of carriage 218.

In accordance with a further aspect of the present invention, since the control system keeps track of the movement of hose 220 and carriage 218 (for example, by sensing pulses from a shaft encoder or other distance measuring device on each of their respective drive motors), the signal generated by the airflow sensor at the time carriage 218 reaches the virtual home can also be used as a check to ensure that control system 400 accurately counted the motor drive pulses, and can re-calibrate the positioning system based on the virtual home, if necessary.

It is noted that position sensor 412 may include the airflow sensor of junction box 229, or in a further embodiment, comprise a mechanically operated plunger-type position sensor associated with pickup head 224. Even furthermore, position sensors 412 may also include a reed switch mounted on a front wall of the cabinet, and a magnet mounted at a leading edge of carriage 218.

Accurate control of energization of blower motor 226 is particularly advantageous in the event that the inside of the cabinet, or a portion thereof, is refrigerated, since accurate control would decrease the amount of refrigerated air being displaced by blower motor 226. In the preferred embodiment, the microprocessor 402 will energize blower motor 226 as the pickup head 224 approaches the desired article, and in fact only when it is in the immediate proximity of the desired article (and not earlier), due to control system 400 maintaining updated information about the height of the stack of articles in each bin 216. The height is assumed to be at a predefined level upon article refilling of the vending machine 10 by the operator. Control system 400 may confirm the assumed height by moving the pickup head 224 at a reduced speed towards an article at the top of a bin 216 on the first retrieval attempt after the storage area has been refilled, and then compare the assumed height to the actual height. Memory 404 can be pre-programmed with specific article heights in advance, or the heights can be learned by control system 400 by comparison of prior vend heights in each bin. Once the height of the top article is known, control system 400 will be able to always know the height of the next “top” article in that bin. Subsequently, control system 400 may cause the pickup head 224 to approach the articles in that storage area at a higher speed, and only slow down when in the immediate proximity of the next “top” article in that bin. The technique to slow down upon the pickup head 224 approaching the next article also helps ensure that the stored articles will not be damaged by the pickup head 224.

It is noted that in an alternate embodiment, a simpler way of controlling operation of blower motor 226 and the approach of pickup head 224, without knowing the specific article height, would be to turn on the blower motor 226, or slow down the pickup head 224 just prior to the learned stack height of the prior vend.

When a “reset” switch (not shown) is activated by the machine operator, control system 400 automatically defaults to using the above height detection technique since it can be assumed that the operator may have changed the product load levels and consequently the product heights in each bin.

For the embodiments described herein, it is assumed that energization of the blower motor or other suction creating device, is meant to be equivalent to the appearance of a prompt package securing force, i.e., suction, at the pickup head 224.

A communication system 414 is connected to control system 400 so as to provide article inventory and vending machine operation information to a remote location, as well as to allow for control of the operation of the vending machine from a remote location. In this regard, communication system 414 may include a connection to means for making a wire-line and/or wireless transceiver interface through which a communication link with a remote computer can be established. Additionally, the communication system 414 may communicate with a plurality of other similarly connected vending machines in the same general area and communicate therewith using the wire-line interface or wireless communication. Even furthermore, communication system 414 can provide for communication with multiple vending machines and/or a local server/controller, in a local site along a LAN (local area network), LAWN (a local area wireless network) or a WAN (wide area network). The remote computer may comprise a database which receives and/or accumulates the operational data from one or more vending machines, which data is then accessible (via, e.g., the Internet, using a wired or wireless connection) using appropriate encryption, to others, such as route drivers, machine operators, machine owners, product suppliers, etc. Furthermore, the remote site may give feedback to the vending machines, such as authorization information, which can control its operation, such as allow its continued operation.

Many of the benefits of the invention described herein could also be particularly useful in an article dispensing apparatus of the type having a refrigerated compartment, such as a chest freezer including various doors thereon (such as described for the ice cream dispenser in U.S. Pat. No. 5,240,139), in combination with the forenoted methods and apparatus for creating, sensing and/or maintaining suction at the gripping end of the suction hose.

While this invention has been particularly shown and described with references to preferred embodiments thereof, it will be understood by those skilled in the art that various changes in form and details may be made therein without departing from the spirit and scope of the invention as defined by the appended claims. In fact, many such changes are already noted in this description. Those skilled in the art will recognize, or be able to ascertain using no more than routine experimentation, many more equivalents to the specific embodiments of the invention described specifically herein. For example, although a suction providing air hose 220 has been disclosed in the described preferred embodiments, in fact a solid element having a gripper at its free and, such as a mechanically operated claw (or an electromagnetic device or even a self-contained suction generator), could also be used. Such equivalents are intended to be encompassed in the scope of the appended claims.

A camera that studies product, for spiral or bin machine which studies article after it falls into retrieval area, can alert controller to disable dispensing from one or more of the article storage areas.

The robotic mechanism can be selectively controlled so as to improve the reliability of article identification, i.e., movement of article past the ID system can be slowed, and for flexible bag articles, the article may be “jiggled” so as to change the flex of the bag and thereby improve scanning of a bar-code or better optical recognition of an image.

Scanning for article ID can be at any time for verification and operation purposes, i.e., not just during or as part of a vend cycle, but also between cycles.

Proper operation and dispensing of article may include adherence to predetermined rules, and interaction with the control system for reporting and enforcement purposes, as well as further control of the vending machine for furthering the enforcement purposes. Article identified as unauthorized can be put back in bin, or dispensed and then further article dispensing from that storage area can be disabled.

Article ID apparatus can also be manually used by the machine operator for inventory management.

Use of an optical ID system for spiral/Gravity feed machines to identify article package type, etc. prior to being dispensed, e.g., while article is falling (or rolling, in the case of beverage container etc.) or already landed at the customer retrieval area.

Determination of article ID is made during a dispensing operation, after dispense is initiated and the cycle is irreversible.

Article ID for inventory management, Pay As You Vend (PAYV) equipment financing, or for calculating incentives based on proper operation and/or adherence to rules.

Addition of circuitry enabling remote connectivity of the vending machine for inventory management, as well as for operational control.

It is noted that article identification in accordance with several aspects of the present invention find use in vending apparatus and methods of operation of vending apparatus such as described in U.S. patent application Ser. No. 09/991,767 entitled METHOD AND APPARATUS FOR VENDING GOODS (Attorney Docket No. 01PA20US) filed Nov. 23, 2001, which was attached as EXHIBIT B to the parent application to the present application. Instead of repeating such attachment, U.S. patent application Ser. No. 09/991,767, is hereby incorporated by reference in its entirety. Application and/or modification of the methods and apparatus shown in the U.S. patent application Ser. No. 09/991,767, and then applied to the invention described herein, is intended to be within the scope of this invention and any claims that issue herefrom.

For example, in accordance with a further aspect of the invention, and as described in greater detail below, disabling of the dispensing apparatus, directly or indirectly, in response to data acquired using the article identification device, is contemplated hereby. Furthermore, re-enablement, or prevention of disabling of the dispensing apparatus, directly or indirectly, in response to data acquired using the article identification device, is also contemplated.

Business methods in accordance with such disabling is also contemplated, wherein inoperability of the apparatus is used as an enforcement mechanism to stimulate adherence by an operator or owner of the apparatus to predetermined rules.

In accordance with a still further aspect of the invention, the article identification device is mounted within the dispensing apparatus along a common path taken by the articles as they are moved to the dispensing area. Article identification during dispensing, as compared with, for example, article identification when loading, helps insure that the article identification is truthful.

In accordance with an even further aspect of the invention, a positioning mechanism is coupled to the article extracting device and responsive to control signals for positioning a free end of the device in alignment with a selected longitudinal axes of the storage volume where the articles are stored in row or columnar form, either vertically, horizontally, or at any angle therebetween.

A drive mechanism may be coupled to the article extracting device for moving the free end of the article extracting device in a direction aligned with the longitudinal axes in the storage volume, and thereafter in a predetermined pattern adjacent to the article identification device.

In the above arrangement, the article identification device may use optics to provide article identification, and is controlled to image or scan the articles when they move in the common path.

Any suitable design and implementation of the article ID device 254 may be employed without departing from the spirit and scope of the present invention. For example, the article ID device 254 may employ one or more of an optical technology, such as a bar code scanner (for reading a unique article ID, e.g., a UPC code, preprinted on the goods), an image recognition system, an analog and/or digital still camera, an analog and/or digital video camera. Alternatively, the article ID device 254 may employ electromagnetic technology, such as a radio frequency identification transponder (RFID) or a magnetic reader for article identification using electromagnetic tags included with the goods. Further details concerning suitable implementation hardware for article ID device 254 may be found at www.aimglobal.org, a website of the global trade organization, AIM. This website provides many details concerning article identification and data collection (AIDC).

The article ID device 254 is preferably mounted within the cabinet 12 at a substantially fixed location such that the goods stored in the storage area 215 may be scanned as they are moved from the compartments 216 to the dispensing chute 210 by the electromechanical retrieving device 200 (218, 220, 221, 224, 227, 228 and 230). Alternatively, the article ID scanning may take place before or after such goods dispensing movement. Further, the article ID device 254 may be mounted on the carriage 218 and/or on the free end 221 of the air hose 220. Preferably, only a single article ID device 254 is employed when the electromechanical retrieving device 200 discussed above is used to move the goods from the storage area 215 to the dispensing chute 210. Indeed, the electromechanical retrieving device 200 described herein is preferably operable to move the article 223 past the article ID device 254 to obtain a scan of any of the goods stored in the storage area 215. Details concerning the types of information gleaned from such scanning and uses thereof is discussed more fully below and in the forenoted U.S. patent application Ser. No. 09/991,767.

ID device 254 may be used, either directly or indirectly, in the determination of prescribed data, which data may include at least one of:
(i) a quantum of one or more types of goods sold during one or more predefined periods of time;
(ii) a quantum of one or more brands of goods sold during one or more predefined periods of time;
(iii) a ratio of one or more types of the goods sold to one or more other types of the goods sold in a predefined period of time;
(iv) a ratio of one or more brands of the goods sold to one or more other brands of the goods sold in a predefined period of time;
(v) respective dates of vends (and/or attempted vends) from the vending apparatus;
(vi) respective times of vends (and/or attempted vends) from the vending apparatus;
(vii) information concerning whether a particular good was out of inventory;
(viii) information concerning what a next choice of goods was made by a purchaser when a particular good was out of inventory;
(ix) information concerning whether the vending apparatus was operational.

For example, ID device 254 may be used to monitor information concerning the sales of goods from the vending apparatus, and more specifically, in one embodiment, used in the determination of whether authorized goods are being sold from the vending apparatus 10. The article ID device 254 is preferably operable to obtain at least some of the above listed information by scanning the articles 223 and providing data to the microprocessor 402 of the control system 400 (FIG. 6 of U.S. patent application Ser. No. 09/991,767). In an embodiment where the article ID device 254 includes a bar code scanner, the UPC code on the article 223 may be analyzed to determine the type, the brand, the size, the weight, the expiration data, the package type, the period of manufacture, the place of manufacture, etc. of the goods being vended. This data may be at least temporarily stored in the memory 404 of the control system 400.

One skilled in the art will appreciate that these raw data are suitable for use, in accordance with one aspect of the invention, in determining whether unauthorized goods are being (or have been) vended from the vending apparatus 10. These raw data may be released (as prescribed data) from the vending apparatus 10, e.g., via the communications unit 410, for an externally conducted determination. Preferably, however, the vending apparatus 10 is operable to make the determination as to whether unauthorized goods are being (or have been) vended and, therefore, is operable to determine whether a contractual obligation relating thereto has been met. Thus, the prescribed data may include one or more of the final data as to whether unauthorized goods are being (or have been) vended and, further, whether any contractual obligation relating thereto has been met.

As noted above, disabling of the vending apparatus 10, directly or indirectly, in response to data acquired using the article ID device 254, is contemplated hereby. Furthermore, re-enablement, or prevention of disabling of the vending apparatus 10, directly or indirectly, in response to data acquired using the article ID device 254, is also contemplated hereby.

For example, in the event that unauthorized goods are being (or have been) vended from the vending apparatus 10, the vending apparatus 10 may be partially or wholly shut down or prevented from further vending/dispensing, as described in detail U.S. patent application Ser. No. 09/991,767. Such knowledge of which products are unauthorized may be pre-programmed into the vending apparatus 10 and stored therein in a manner which it can not be tampered with. In this regard, in one embodiment, the vending apparatus 10 preferably includes an electronic means for sensing whether unauthorized removal and/or altering of the various parts thereof, such as control system 400 and/or the peripheral circuits/systems has occurred. Further discussion of such electronic means is provided in greater below.

In accordance with a further aspect of the invention, compliance with a contractual obligation, for example to maintain inventory of one or more goods in the vending apparatus 10, is preferable determined from data acquired by the vending apparatus 10 via article ID device 254. To this end, the vending apparatus 10 is preferably operable to monitor one or more parameters concerning the inventory of one or more goods stored therein and collecting the prescribed data (whether in final form or in raw data form, from which the final data may be computed and/or generated).

The control system 400 in combination with the electromechanical retrieving device 200 and article ID device 254, may be capable of conducting an inventory action on the goods stored within the vending apparatus 10. In one embodiment, the electromechanical retrieving device 200 may be commanded by the control system 400 to remove goods to be inventoried from their positions within the storage area 215 (and to hold them temporarily in an alternative location within the storage area 215, if necessary) while the control system 400 in combination with the article ID device 254 counts the quanta of goods of a particular type, brand, size, weight, expiration data, package type, period of manufacture, place of manufacture, etc.

It is noted that the above described article identification for purposes of, for example, determining dispensing of authorized goods and/or maintenance of a prescribed inventory, does not require article identification for each and every article which is dispensed. That is, the article identification can be done in a random “skipping” manner, i.e. scanning less than at each and every vend, and even furthermore article identification can be done in a predetermined “skipping” manner which uses statistical analysis (interpolation) in order to determine compliance with a prescribed obligation. Furthermore, the control portion of the apparatus may allow a limited number of dispensing operations in the event that article identification is not successful and may even allow a limited number of dispensing operations even if a prescribed obligation is not met. In this case the control portion of the apparatus may allow the dispensing operation to continue for a predetermined number of cycles after an unsuccessful or unauthorized article identification, before disabling the apparatus.

An article dispensing apparatus which takes particular advantage of this concept may comprise,
an article storage volume which stores articles to be dispensed in predetermined article storage compartments, where there is requirement that articles of different types not be stored in the same article storage area
an article retrieving device which moves selected articles from the storage volume to a customer retrieval area
an article identification device which identifies articles before, during or after they are moved from the storage volume into the customer retrieval area, and
a graphics display associated with the dispensing apparatus, which graphics display provides article selection information to a user of the dispensing apparatus,
wherein the user is unable to see the actual articles in the storage area and must rely on the graphics display for article selection.

In such an arrangement, n the event that there is and obligation to only dispense authorized products, the controller portion of the article dispensing apparatus is not required to have the ability to identify each and every dispensed article, since the controller can assumed that the operator has filled the storage compartments properly. That is, if the storage compartments were not filled properly, the user would not receive the desired article, and such disappointments would greatly reduce use, and consequently profits, from that dispensing apparatus.

Indeed, as discussed above, the article ID device 254 may be used to obtain at least some of the above listed information by scanning the articles 223 and providing data to the microprocessor 402 of the control system 400. For example, when the article ID device 254 includes a bar code scanner, the UPC code on the article 223 may be analyzed to determine the type, the brand, the size, the weight, the expiration data, the package type, the period of manufacture, the place of manufacture, etc. of the goods being maintained in the vending apparatus 10. This data may be at least temporarily stored in the memory 404 of the control system 400.

In this way, raw data may be obtained to determine whether prescribed inventories are being maintained. These raw data may be released (as prescribed data) from the vending apparatus 10, e.g., via the communications unit 410, for an externally conducted determination. Preferably, however, the vending apparatus 10 is operable to make the determination as to whether prescribed inventories are being maintained and, therefore, is operable to determine whether the contractual obligation relating thereto has been met. For example, information concerning what the one or more prescribed inventories must be may be stored in the memory 404 of the control system 400. The microprocessor 402 of the control system 400 is preferable operable to compare the one or more prescribed inventories with the raw data relating to the actual inventories being maintained in the vending apparatus 10. The result of the comparison yields the final data, e.g., the determination as to whether the one or more prescribed inventories are being maintained. Further, the result may yield other final data, such as whether the contractual obligation relating to whether the one or more prescribed inventories are being maintained has been met.

The discussion immediately above has substantial applicability to determining whether the obligation to maintain a prescribed ratio of space occupied by one or more goods stored in the vending apparatus 10 to the storage space available within the vending apparatus 10. Indeed, the space available within the vending apparatus (e.g., the size of the storage area 215) is available to the microprocessor 402, for example, by way of the memory 404, then the data obtained via the inventory operation conducted by the control system 400, the article ID device 254, and the electromechanical retrieving device 200 may be: (i) released by the vending apparatus (e.g., via communications unit 410) for and external determination; (ii) used to internally compute (e.g., via the microprocessor 402) the actual ratio of space occupied by one or more goods stored in the vending apparatus 10 to the storage space available; (iii) used to determine whether the prescribed ratio is being maintained within the vending apparatus; and/or (iv) whether the contractual obligation relating to the prescribed ratio has been met.

One skilled in the art will appreciate that this raw data may be utilized to determine whether the prescribed ratio of one or more of the goods to one or more others of the goods have been sold from the vending apparatus 10, or other information, such as determining whether a prescribed quanta of money was received at the vending apparatus 10 in a predefined period of time.

The concept of at least partially disabling the vending apparatus 10 from dispensing at least some of the goods stored therein has been discussed above (see also FIGS. 7-12 of U.S. patent application Ser. No. 09/991,767) and will be further considered hereinbelow. It is noted that those skilled in the art will appreciate from the disclosure herein that the particular mechanism and/or process for disabling the vending apparatus 10 may vary. A determination as to whether the vending apparatus 10 should be disabled may be made externally (e.g., via an external computer system) or internally (e.g., via the control system 400) and a corresponding external and/or internal disable signal generated to cause the vending apparatus 10 to become at least partially disabled. For example, the control system 400 may prevent the electromechanical retrieving device 200 from moving to the X, Y position of one or more of the containers 216. Alternatively, the control system 400 may prevent the air hose 220 from moving into contact with the article 223 and/or may prevent vacuum action when the X, Y positions of the carriage 218 corresponds to a container 216 that contains goods that are “disabled” from being vended. Another alternative way to disable the dispensing of goods may include requiring that the retrieving device 200 return the article 223 to the storage area 215 instead of placing it in the dispensing chute 210. A further alternative may be to disable the dispensing chute 210, the bill acceptor mechanism 26, the coin acceptor mechanism 28, the card acceptor mechanism 34, etc. Still further, one or more motors and/or electromechanical devices may be disabled.

In one embodiment, a condition that triggers the desirability to at least partially disable the vending apparatus 10 may occur and the timing of actually disabling the vending apparatus 10 may occur anytime afterwards (e.g., after a current vend is completed as opposed to prohibiting the current vend to complete). The condition may be the detection by the article ID device 254 that an unauthorized good has been detected and the at least partial disablement may be prohibiting further vending from the corresponding compartment 216.

It is noted that an unscrupulous party may be motivated to attempt to alter the nature of the vending apparatus 10 such that it will not at least partially disable in accordance with the invention as described in the embodiments herein. For example, if the function of partly or fully disabling the vending apparatus 10 is carried out by way of a software program running on the microprocessor 402 platform of the control system 400 as discussed above, then an unscrupulous party may seek to remove the control system 400 from the vending apparatus 10 and replace it with a substitute control system that does not disable the vending apparatus 10.

In order to thwart the unauthorized modification of one or more components of the vending apparatus 10, the vending apparatus 10 preferably includes at least one of an electronic, an electromechanical, and/or a mechanical means for sensing whether an unauthorized modification of the vending apparatus 10 has occurred and, if so, at least partially disabling the vending apparatus 10 from dispensing goods. To that end, the control system 400 and/or the peripheral systems/circuits preferably include an electronic security circuit that is operatively coupled to, or in operative communication with, a receiving circuit such that unauthorized removal and/or alteration of the control system 400 and/or the peripheral systems/circuits may be sensed by the receiving circuit. The electronic security circuit 50 may produce a unique code that when received indicates an authorized removal and/or the alteration of the vending apparatus 10. Any of the known electronic security circuits may be utilized to implement the electronic security circuit 50, such as a MicroChip encryption security chip. Alternatively, the circuit 50 may be a radio frequency identification (RFID) tag (with corresponding reader) as may be obtained, for example, from Motorola of San Jose, Calif. As is known in the art, the electronic security circuit 50 preferably communicates with the receiving circuit (or circuits) by way of hard wire, wireless communication, etc. and preferably utilizes encryption. Further details concerning suitable implementation hardware for the electronic security circuits 50 may be found at www.aimglobal.org, a website of the global trade organization, AIM. In this regard, it is also noted that in the event the apparatus is disabled due to tamper sensing, even if the tampered component(s) are properly replaced, before the dispensing apparatus again becomes operative, a re-enable code may be required.

The following numbered paragraphs supplement the above description:

1. A dispensing apparatus including an ID device operable to scan each article of goods that is dispensed from the apparatus and which ID device provides information to a processing unit of the dispensing apparatus as to whether a limitation is either met or violated, wherein the limitation is one of: that the vending apparatus is required to vend only authorized goods,
that the vending apparatus authorized to only vend a certain dollar amount of sales,
that the vending apparatus is authorized to only vend a certain number of products,
wherein the above authorizations are to be considered alone, or in combination with, a predetermined time interval.

2. The apparatus of paragraph 1, wherein the article ID device includes at least one of a bar code scanner (reader), an optical reader, an image recognition system, an analog and/or digital still camera, an analog and/or digital video camera, a radio frequency identification device, and a magnetic reader.

3. The apparatus of paragraph 1, wherein the processing unit is further operable to enable the apparatus for sequential intervals of operation, so long as respective continuation codes are received by the apparatus for each interval, and wherein no two sequential continuation codes are identical.

4. The apparatus of paragraph 1, wherein the processing unit is further operable to automatically enable the apparatus after a predefined period of time has elapsed after the apparatus has been disabled.

4′. The apparatus of paragraph 1, wherein the disabling of said dispensing is overcome, or re-enabled, in response to input to the processing unit of an encoded authorizing signal.

4″. The apparatus of paragraph 1, wherein the, wherein disabling of said dispensing is overcome, or re-enabled, in response to the passage of time.

5. The apparatus of paragraph 1, wherein the article identification device comprises an imaging system, such as an analogue or digital, still or video, camera, coupled to an image analysis device that recognizes predetermined images (color/pattern or texture, etc) thereby providing the article identifications.

6. The apparatus of paragraph 1, wherein a drive means causes the article extracting device to perform a discontinuous movement in the area of the article identification device, as the article moves from the article storage area to the dispensing area. This movement is controlled for the purpose to facilitated an improved “view” of the article by the article ID device.

7. The apparatus and a business method in accordance with paragraph 1, wherein the article identification is used by a user interface and control apparatus for making all or part of the apparatus inoperable.

8. A business method in accordance with paragraph 7, wherein partial inoperability of the apparatus prevents dispensing of articles from at least one portion of the storage volume.

9. A business method in accordance with paragraph 7, wherein inoperability of the apparatus is used as an enforcement mechanism to stimulate adherence by an operator or owner of the apparatus to predetermined rules.

10. A business method in accordance with paragraph 7 or 9, wherein inoperability of the apparatus is used as an enforcement mechanism to stimulate reporting of sales and inventory data to a central authority.

11. A business method in accordance with paragraph 7 or 9, wherein inoperability of the apparatus is used as an enforcement mechanism to stimulate adherence to plan-o-grams (proper article layout by person stocking the apparatus with article, i.e., the route driver).

12. A business method in accordance with paragraph 11, wherein an incentive or bonus is provided to the route driver for adherence to the plan-o-grams.

13 A business method in accordance with paragraph 12, wherein the apparatus includes an optional interior display so the route driver can monitor the bonus or incentive program.

14. Apparatus in accordance with paragraph 1, wherein in the event that a specific article is not successfully identified, the vending apparatus is able to interpolate/assume the article id of that specific article based on the successful id of other articles which have previously been identified and which were stored and retrieved from a same predetermined portion of the storage volume as where the unidentified article was retrieved from.

In the above described apparatus, it was noted that the article identification device is mounted within the dispensing apparatus along a common path taken by the articles as they are moved to the dispensing area. Accordingly, the article retrieving device may be controlled to make a predetermined pattern of movement, i.e. repositioning, in the area of the article identification device, in an effort to aid the article identification, such as the movement noted in paragraph 6 above. In this regard, such movement may comprise a sudden jostling type of movement, which may be useful, for example, to smooth out the wrinkles in a flexible bag, and thereby make its bar code more easily identifiable, or pattern such as would provide multiple opportunities for the article ID device to scan the article. Even furthermore, the control system of the dispensing apparatus may “learn” from repeated patterns and the success of their results, so as to provide improved patterns for future dispensing which would result in a greater percentage of the articles being successfully scanned.

15. Apparatus as described in the first of the above noted aspects of the invention, whereby an article stored in the storage volume can be identified by the article id system:

By removing the article from the storage volume and moving the article adjacent to an identification area where the article can be identified, such moving being made by a conventionally known spiral mechanism or by a robot device,

Prior to the article coming to rest in an article retrieval area, or

Prior to article being placed back in that portion of the storage volume of origin, or

Prior to the article moving to a different portion of the storage volume, or

Within the article retrieval area.

The following description, originally attached as pages 4-8 near the end of the parent application, supplements the above description.

The article ID system, preferably a vision system, can be used to inspect a package for damage or other defects or reasons to reject vending it. This operation and other uses of the ID system using a bar code reader or other device and their related monitoring procedures may be beneficially operable in between dispensing cycles and are not restricted only to working during a vend cycle.

After inspection or identification by the ID device, an article may then be vended, or placed back into the storage bin or compartment from which it was retrieved, or still further my be placed into a holding area, for example for the purpose of inspection by a person at a later point in time.

Images from the camera or video camera mounted within the housing or cabinet can be displayed on a display screen or video monitor, which may be visible to the user. In this way, a user may be able to see the operation of the machine while still not easily being able to break a glass window, such a window would otherwise be necessary for viewing purposes typical in a spiral vending machine. Images of the operation or condition of the machine may also be transmitted or stored and communicated electronically, for example over the internet or another communication network to a remote site where a person could use the camera, especially if the camera is mounted on a remote controlled mounting, to inspect for damage to the machine, to troubleshoot or diagnose a technical problem, or simply view any other aspect of the inventory details or performance of various parts of the apparatus. A camera may also be used to capture images of vandals who approach the machine, or who gain access to the machine. Images may be stored electronically at the location of the machine or at a remote site, using either the computer control system of the apparatus, or a separate computer system which may be located within the apparatus or remote to the apparatus.

The information gathered from the control system and or the ID device may be used to enable software in a computer system to calculate parameter which at least a partially is utilized in order to determine the pay or compensation of at least one person or entity such as a route person who loads the machine or a managing entity which is responsible for maintaining the equipment to a specified standard.

In an embodiment where the dispensing apparatus is a spiral vending machine, the camera, optics, RF or other device or multiple devices may be strategically located at or near the customer retrieval area, where the ID device may identify the article as it is falling or after it has fallen into the retrieval area. Advantageously, at least one camera may be mounted in a position so as to be able to view multiple articles when they are still within the storage compartments, on the shelves, or in the bins and therefore, the camera can be used to identify any one of multiple articles which have been stored in one of several storage locations. The camera, lens or ID device in this embodiment can further be operable to move and thereby change its viewing angle in order to allow the control system to guide the view of the storage area or article desired to be viewed. As described before, this ID monitoring may be utilized before, during, or after the occurrence of a vend cycle. In the embodiment of a horizontal shelf machine, such as with bins on horizontal shelves and a robot or in the case of horizontal shelves with spiral dispensers mounted within, the camera or ID device or devices may be mounted facing and or opposing the face of the articles sitting on the shelves. In the case where the article dispensing includes a conveyor belt or other conveyance is required in order for the article to be transferred to the customer retrieval area, the camera or ID device may be mounted at one end of the conveying path or anywhere along the conveying path.

The control system may have accessible stored within it, or stored remotely from it, data which specifies the type of parameters such as bar codes that are acceptable or authorized to be within or in use by the machine. The computer system is operable to makes a comparison between the data stored in the computer memory and the data being monitored from within the machine or relating to the machine. At that point the control system is able to make a determination of what, if any, further action or inaction needs to taken.

The control system may also operate the robot to automatically search for a specific article using the robot and the ID device. The computer can operate the robot to remove articles from the bins, or in another embodiment use a camera and vision or optical recognition software, in order to study the articles in their storage areas without the need for removal. Still further the control system may use the learned information to automatically update inventory, restrict certain articles from sale, reconfigure a user display which displays graphics or identifications of the articles stored within a storage area.

Some aspects of the present invention may also be embodied by mounting the ID device onto the retrieval system, such as mounting the ID device onto the end of the hose. In the case of a RF transmitting device, for example, the wires for the device, mounted on or near the end of the hose, can travel through the hose. The ID device could also be mounted to other points on the positioning mechanism in order to get a good viewing position. For example, the camera or ID device may be mounted to the x-y carriage (or in a horizontal embodiment, the x-y shelf) so that the control system can move the camera and position it in order to inspect and identify the articles stored in the compartments, shelves or bins.

The control system may be operable to move the positioning system while searching for an identification of an article and continue the various motions until the identification is made or alternately until some preset time limit has been reached.

The robot and control system can “learn” to improve speed and accuracy of locating the bar code or identifying mark of a given type of package by “learning” the specific features of the package either by having that intelligence preprogrammed about a specific package, or by cumulative learning by trial and error.

The optical scanner or the camera can also be used to identify an article based on a logo, artwork, or package color.

The ID device can be used to identify many types of parameters of an article. This is enhanced by having coded information attached to the article, such as in an ID tag or in a bar code etc.

The ID device search for an article parameter can be operable as a random event for audit purposes where the unit doesn't have to scan every package.

The ID device and the control system can interpolate where the assumption is made, that if a code can not be discerned the machine will still vend and look for an average number of successful scans from a specific storage compartment. So a limited number of vends may be allowed to occur in a compartment even if no product ID can be found, or further, a limited number of vends can be vended even if the article has the wrong code after an allowed number of failed attempts to get an authorized parameter the control system may then, for example, disable access to a specific bin or disable the entire machine.

The bar code in combination with articles of multiple articles being stored in a row or column in conjunction with not being able to view the article from the outside of the machine in combination with a selection graphic or button has a specific ability to prevent an operator from trying to cheat the system. By placing unauthorized goods intermingled with authorized goods, the user will have to assume that the product related to that selection graphic or button is all the same. If different items, some authorized and some not authorized, are both present within the same column, row or bin, the user will not find the result acceptable. This scenario is important since it allows more tolerance on part of the control system to interpolate that if some of the items in a bin are the correct ones, therefore the articles which may not be able to be scanned are most likely the same type of article.

In one embodiment of a multiple robot configuration may be contained within a warehousing structure. The system can utilize a common computer system to control all processes including conveyance, dispensing and monitoring whereby at least one conveyor system for moving a containment structure, such as a bag, basket, box or other type of container from one location to another, the system further having at least two robots are positioned so as to be operative to remove articles from storage bins (eg. Typically articles of different types with different storage requirements) within the reach of the respective robots. The conveyor system which may be of many varied methods generally known can convey the container in order to allow the robots to place articles within their reach into the common bag or box prior to dispensing or conveying the container or box to a customer retrieval location. This customer retrieval location or locations can be remote to the housing structure that contains the article storage facilities and or the article conveyor systems. Additionally the other described aspects of the invention, such as article ID systems, control techniques and mechanical apparatus described herein may be applied to this embodiment. Other aspects that can be utilized advantageously here may be connection to a computer network such as the internet, LAN, WAN, Wireless etc. wherein a customer or user may monitor or order from the system. In one scenario, the user can order articles to be dispensed over the computer network and have them ready and waiting in a customer holding area so that the customer can retrieve the container or articles at a later time. A user can also use a touch screen in proximity to the automated dispensing system or retrieval area and or the remote computer system or network to check the inventory or availability of a specific item or items. In a further embodiment, This system can also be utilized as a mini warehouse system. In this scenario, the storage areas may contain articles or packages which are placed there specifically for access and retrieval by a certain person or entity. Using a passcode or access card or similar device or using a payment method, the user can retrieve packages such as parcels, letters, or other shipped goods from the storage area. This provides for a very convenient system since traditional deliveries to a person or entities home or place of business often requiring a physical signature and for a both parties to be present to receive and have the article delivered. Instead, the delivering party and the receiving party can use the article storage and dispensing apparatus as an exchange device allowing for the two parties to carry out the transfer of goods without having the requirement of being at the same place at the same time. Additionally, the use of a pass code or a swipe card, which may be connected to a gasoline pump, or any one of a multitude of devices, including biometric devices such as facial or fingerprint recognition, could be used as a verifiable electronic signature to ensure accountability. The elements described herein can be used in various other useful combinations which are considered part of the invention.

This dispensing apparatus can be used in locations such as Gas Station islands, parking lots or convenience stores etc. whereby products are delivered to customers from the dispensing apparatus, for example, using a pneumatic tube, or a conveyor system bringing articles from a remote storage area of the vending apparatus to a location on the perimeter of the apparatus housing, or to location external and or remote to the housing of the apparatus whereby the customer interface, such as a touch screen device and remote retrieval area can be accessed by the customer for remote delivery of articles conveyed and dispensed from the vending apparatus. The described invention can be used in an automated supermarket and such things as automated storerooms or stockrooms in office buildings and commercial locations.

Thus, there has been provided in accordance with the invention a method to activate a vending machine or other automatic dispenser that fully satisfies the objects, aims and advantages set forth above. While the invention has been described in conjunction with specific embodiments thereof, it is evident that many alterative, modifications and variations will be apparent to those skilled in the art in light of the foregoing description. Accordingly, it is intended to embrace all such alternatives, modifications and variations as fall within the spirit and broad scope of the invention.

1. An article dispensing apparatus, comprising:
a storage volume for storing a plurality of articles to be dispensed;
an article extracting device including a free end for selectively grasping to and extracting an article from the storage volume;
user interface and control apparatus for allowing a user of the dispensing apparatus to initiate an article dispensing operation, and to cause controlled movement of the article extracting device so that a selected article is extracted from the article storage area and moves along a common path to a point within the dispensing apparatus that is associated with a dispensing area of the dispensing apparatus, and
an article identification device, mounted at a point within the dispensing apparatus that is near the common path, and operated so as to provide identification scanning of an article while the article is still being grasped by the article extracting device and while the article is still being moved by the article extracting device, as the article moves along the common path during the dispensing operation.

2. The apparatus of claim 1, wherein the article extracting device causes the article to make a predetermined movement in relation to the position of the article identification device so as to aid identification of the article by the article identification device, as the article moves from the article storage volume to the point associated with the dispensing area.

3. The apparatus of claim 2, wherein said predetermined movement results from said article extracting device being controlled to make a repetitive movement in relation to the position of the article identification device.

4. The apparatus of claim 2, wherein said predetermined movement comprises a departure from the common path.

5. The apparatus of claim 1, wherein the article identification device comprises a bar code scanner

6. The apparatus of claim 1, wherein the article identification device comprises an optical reader.

7. The apparatus of claim 1, wherein the article identification device comprises an image recognition system using a still image camera.

8. The apparatus of claim 1, wherein the article identification device comprises an image recognition system using a video camera.

9. The apparatus of claim 1, wherein the article identification device comprises a radio frequency identification device.

10. The apparatus of claim 1, wherein the article identification device comprises a magnetic reader.

11. The apparatus of claim 1, further including:
a positioning mechanism coupled to the article extracting device and responsive to control signals for positioning the free end of the device in alignment with a selected article in the storage volume; and
a drive mechanism coupled to the article extracting device for moving the free end thereof in a direction toward or away an article in the storage volume.

12. A method of operating an article dispensing apparatus, comprising:
storing a plurality of articles to be dispensed in a storage volume;
selectively grasping to and extracting an article from the storage volume using an article extracting device;
allowing a user of the dispensing apparatus to initiate an article dispensing operation, and to cause controlled movement of the article extracting device so that a selected article is extracted from the article storage area and moves along a common path to a point within the dispensing apparatus that is associated with a dispensing area of the dispensing apparatus, and
providing an identification scanning of an article while the article is still being grasped by the article extracting device and while the article is still being moved by the article extracting device, as the article moves along the common path during the dispensing operation.
